(19) United States
(12) Patent Application Publication
(10) Pub. No.: US 2003/0172765 A1
(43) Pub. Date: Sep. 18, 2003

(54) Adjusting and fixing device for a steering shaft, whose height and/or length can be adjusted

(76) Inventor: Roland Heiml, Vocklamarkt (AT)

Correspondence Address: WILLIAM COLLARD, COLLARD & ROE, P.C., 1077 NORTHERN BOULEVARD, ROSLYN, NY, 11576, US

(21) Appl. No.: 10/258,069

(22) PCT Filed: Apr. 11, 2001
(86) PCT No.: PCT/AT01/00104

(51) Int. Cl. B62D 1/18

(52) U.S. Cl. 74/493; 280/775

(57) ABSTRACT

The invention relates to an adjusting mechanism (3) for a steering shaft (2) for adjusting the length and/or inclination, and at least one fixing system (4) fixing the adjusted position, which has a tensioning element (24) extending transversely to the longitudinal axis of the steering shaft (2), on which fixing mechanisms (13; 14) are provided which can be adjusted relative to one another in the longitudinal direction by means of a lever (84), each having at least one base element with at least one clamping element, at least one guide element and at least one resilient element, in which at least one clamping element is disposed between the steering shaft (2) and the bearing element (10) and/or between the mount (5) and the lever (84), and in a locked position the clamping element or the clamping elements releasably fix the steering shaft (2) or the bearing element (10) and/or the mount (5) in its position relative to the tensioning element (24) against the action of the elastically deformable resilient element by means of an intermittent and/or linear friction connection.

The invention relates to an adjusting mechanism for a steering shaft, of the type outlined in the generic part of claims 1, and a fixing mechanism of the type outlined in the generic part of claim 75.

Patent specification DE 196 43 203 A1 describes a steering shaft adjusting unit with an adjusting mechanism and a co-operating fixing mechanism, whereby a steering shaft is displaceable in the direction of the longitudinal axis and can be pivoted transversely to the longitudinal extension of the steering shaft relative to a stationary retaining point disposed in a vehicle. Co-operating with a tension bolt extending transversely to the longitudinal axis of the steering shaft are two fixing mechanisms which are adjustable relative to one another by means of an operating lever and respectively comprise a base element with a clamping element, a guide element and at least one resilient element, the clamping elements of which mesh in a positive engagement with a toothed clamping element of the bearing element in the locked position and fix the steering shaft in the adjusted position. A steering shaft adjusting unit of this type entails a high degree of manufacturing complexity and has a plurality of different, structurally awkward components, which can not be produced without highly complex, cost-intensive machinery. Furthermore, an adjustment procedure from a locked position into an open position requires long paths in order to lift the teeth of the clamping element from the matching teeth of the bearing element and retaining system, which means that the structural design of the fixing mechanism must be structurally robust, whilst necessarily requiring a large amount of space.

A steering shaft adjusting unit of this type for adjusting and fixing a steering shaft in a motor vehicle with an adjusting mechanism and a fixing mechanism co-operating therewith is already known, being made by Volkswagen AG, in which the steering shaft adjusting unit extends at least across a part of a bearing element enclosing the steering shaft, mounted so as to be pivotable on the chassis about an axis perpendicular to the steering shaft, and is provided with a guide unit for a locking device for the longitudinal adjustment, formed by the retaining system, connected to the bearing element and permanently fixed to the body, fitted with two oppositely lying fixing devices, which receive the clamping elements, in particular having discs, which are designed to generate a friction connection in the clamped state, thereby affording a fixing action. The disadvantage of this approach is that high friction forces have to be generated between the individual discs and the locking mechanism to secure a fixing effect, and the adjusting and fixing mechanism must be made to a correspondingly robust design.

Another steering shaft adjusting unit with an adjusting mechanism co-operating with a fixing mechanism is known from published patent specification EP 0 496 387 A2, in the single-part, slotted clamping element at least partially surrounding the periphery of the bearing element and mounted transversely to the longitudinal extension thereof is received in a height adjustment fixing mechanism mounted on the body, which permits a pivoting motion of the steering shaft relative to its vertically extending axis. Mounted in a tensioning element, the clamping element is joined to the circular bearing element and is operated by means of the lever, which is integral with the tensioning element in displacement and generates a friction connection between the bearing element and the clamping element in the clamped state. The disadvantage of this solution is that fixing can only be achieved by applying high operating forces and this leads to increased wear and hence a poorer fixture.

The underlying objective of the present invention is to propose an adjusting and fixing mechanism which consists of few individual components and which can be readily adjusted and reliably fixed.

This objective is achieved by the invention as a result of the characterising features defined in claim 1. The surprising advantage of this solution resides in the fact that the design of the clamping elements of the fixing mechanism are able to produce a reliable fixing action in any adjusted position, in spite of the low operating forces, in the clamped state. The simple structure comprising few individual components lends itself to simple assembly, for example on a mass production line, incurring little in the way of production costs. Furthermore, as a result of the low operating forces, the individual components of the entire structure can be made to a thin-walled design, which makes for a considerable saving in weight and costs.

Claims 2 and 3 define other advantageous embodiments because the distance left between the clamping elements and the surface in the open position is gentler on the surfaces of the bearing element as well as the retaining system and clamping elements during the adjustment procedure, which makes for a substantially wear-free adjustment process. Another advantage is the fact that the components are slightly biassed relative to one another by a biassing force generated by the resilient element so that they exert a slight resistance during adjustment, enabling a light-handed manual adjustment to be made due to their co-operation with the intrinsic weight of the components. Furthermore, the guide elements overlapping with the surfaces in at least certain regions make for a noise-free and gentle adjustment process.

An embodiment defined in claim 4 is also of advantage because in the fixing locked position, the clamping elements sit at least in an intermittent arrangement against the surfaces of the bearing element and retaining system and are pressed against them with pre-settable forces.

The fact that the standardised, inexpensive clamping element can be used for the embodiment defined in claim 5 is an advantage.

In accordance with claim 6, the base element, the guide element and optionally the resilient element are accommodated in a way that enables them to be positioned.

As a result of the embodiments defined in claims 7 and 8, every combination of a friction-fit or positive-fit fixing system is possible.

Also of advantage is an embodiment defined in claim 9, which offers a component unit forming a compact and robust steering shaft adjustment unit affording a high degree of stiffness in the axial direction and in the direction disposed radially thereto, even if the individual components are of a thin-walled construction and design.

One embodiment defined in claim 10 enables the use of universal, inexpensive components, which offer a high degree of stiffness in the direction of the steering shaft.

The advantage of the embodiments defined in claims 11 and 12 is that the cutout not need to be made to a high degree of manufacturing accuracy, which makes production of the overall unit cost-effective.

As a result of another embodiment defined in claim 13, the adjustment path for the inclination of the steering shaft is bounded by the end regions of the cutout, obviating the need for additional restricting elements.

As a result of the embodiment described in claim 14, the transverse stiffness of the steering shaft adjusting unit can be significantly increased, so that a force or energy acting obliquely on the steering shaft in the event of an accident can be largely absorbed and the risk of injury to a vehicle passenger minimised.

By virtue of the embodiment defined in claim 15, the clamping element is of the simplest structural design and prevents any inadvertent shifting or displacement of the steering shaft in the direction of the longitudinal axis and/or in a direction extending transversely thereto.

In this respect, an embodiment as defined in claim 16 has proved to be of advantage since, on the one hand, it enables the transverse stiffness to be increased and, on the other hand, serves as a protective feature against external influences, in particular dirt, because the guide units are encased, at least in certain regions.

By virtue of the advantageous embodiments defined in claims 17 to 21, the bearing element can be readily adjusted relative to the profiled piece in the longitudinal direction of the steering shaft, giving maintenance-free operation of the steering shaft adjusting unit over a long period of use. Another advantage resides in the fact that the bearing element provided with the guide elements is easy to assemble with the profiled piece. This enables assembly with simply mounted manipulating systems integrated in a production line.

Also of advantage is an embodiment as defined in claims 22 to 23, since the fact that the cutout and the orifice overlap in certain regions during adjustment in one and/or in two directions restricts the mutually adjustable components in their end positions.

As defined in claims 24 to 28, several open profiled cross sections can be made from cut and/or punched and/or bent parts, which form a multi-cornered cross section in a plane perpendicular to that receiving their longitudinal extension, thereby affording a high degree of stiffness. The bearing element, which comprises a small number of parts, can be made to within the most narrow limits of tolerance, which makes for fault-free operation in terms of adjusting and fixing the height and inclination of a steering shaft for an unlimited period of use.

In accordance with the embodiments defined in claims 29 to 31, preferably two components are used and in a non-clamped open position enable a comfortable longitudinal sliding action, whereas the clamping forces which occur in the closed position can be more uniformly transmitted to the profiled piece because of the structural design. As the guide elements are brought into abutment in the closed position, the bearing element and the guide elements can be securely fixed relative to the profiled piece and its guide mechanism and relative to the holding mechanism, even with low clamping forces.

An embodiment defined in claim 32 provides a high degree of stability and/or resistance to twisting, even when the bearing element is fully extracted.

The use of force-supporting elements as defined in claim 33 means that only light operating forces are needed to overcome the forces exerted by the resilient elements.

Also of advantage is the embodiment described in claims 34 and 35, which enables the number of individual components to be reduced, significantly reducing complexity in terms of assembling and producing a steering shaft adjusting unit.

Also of advantage is an embodiment as defined in claim 36, since the base element which provides the surface for the clamping elements can be made larger, thereby ensuring a more secure fixture.

An embodiment defined in claim 37 offers the advantage of ensuring that the resilient element is not susceptible to wear caused by friction.

The embodiment defined in claim 38 provides a space-saving mounting for the clamping element, preventing it from turning.

Also of advantage are the embodiments defined in claims 39 to 42, since the component is preferably made from a block-shaped raw material and involves few production steps to produce a component offering multiple functions, the material integrity of the integrally formed clamping elements preferably being obtained by a partial hardening, in particular hardening during use, which makes for improved toughness and a resultant high strength relative to the basic body of the base element. By preference, the first part of the bearing element and the clamping elements of the base elements are of the same strengths, but may optionally be of different strengths, which can prevent the occurrence of fatigue on the clamping elements and the surface of the bearing element and/or retaining system.

Also of advantage is the embodiment defined in claim 43, because even slight variations in tolerance, in particular as regards the bending radius of the first part of the bearing element, will not have a detrimental effect on the fixing action.

The embodiments described in claims 44 and 45 are of advantage because the toothed elements provide either intermittent and/or linear contact points with the surface so that any variances in tolerances which arise in the longitudinal extension of the bearing element and/or the mount will not have any significant effect on the efficiency of the fixing mechanism. As a result of the intermittent and/or linear friction fit between a plurality of toothed elements and the surface of the bearing element and/or the mount, it will not be necessary for the base element to be applied with such high pressing force against the surface in order to obtain a secure fixture, which means that the overall size and the space needed to mount all the individual components can be considerably reduced.

Claim 46, on the one hand offers a longitudinal guiding action across the entire adjustment path when making an adjustment, whilst on the other limits the adjustment path.

As a result of the embodiments defined in claims 47 to 49, the base element, which serves several functions, operates as a guide element and stop element, and is preferably integrally formed on it and of the same material as it. This enables the number of individual components and manufacturing costs to be reduced. Furthermore, providing guide and/or stop elements, preferably several, integrally formed on the base element makes for a more robust structure, preventing any jamming in the cutout.

The structural design defined in claim 50 is also of advantage because the base element is always reliably guided in the bearing element, especially in the cutout.

It is also of advantage to use standardised and inexpensive resilient elements which can be relied on in operation, as described in claims 51 and 52.

The embodiments defined in claims 53 and 54 are of advantage because they enable a guide element with substantially the same cross-sectional as the base element to be accommodated in a compact arrangement in the fixing mechanism.

The embodiments defined in claims 55 to 59 offer advantages because any kinetic energy released by the guide and/or stop elements as they impact with one of the damping elements can be absorbed by the latter and any residual kinetic impact energy generated if the pre-settable adjustment path is exceeded can be absorbed by the two mutually opposite stop surfaces of the cutout without casing wear or damage.

High clamping forces can be achieved by the designs described in claims 60 and 61, ensuring a secure fixture even in the event of changing and impact loads during operation.

Force-supporting elements are provided in accordance with claim 62, which make the fixing mechanism easy to operate.

As a result of one advantageous embodiment, defined in claim 63, a corresponding clamping force is obtained in order to set the clamping torque between components if necessary, in particular the bearing element and the mount.

Also of advantage is an embodiment as defined in claim 64, which helps to enhance bending resistance when the steering shaft is mounted in the bearing element.

Claim 65 describes another advantageous embodiment since providing two components, preferably made from plastics, opposite one another makes for a noise-free adjustment which is gentle on the material. Another advantage of this solution is that at least one fixing mechanism with a plastics disc and a sheet metal disc is retained in position and co-operates with the bearing element, preferably prior to the final assembly process, making up a separate component unit which can then be readily assembled with the other components without a great deal of complexity in terms of assembly.

Also of advantage are the embodiments defined in claims 66 to 74, which enable remote adjustment and fixing in one and/or two spatial directions by means of drive systems, which are activated for adjustment purposes via a preferably centralised control unit, the pre-set positions of which are stored in and can be retrieved from a memory when necessary. A reliable operating system can be set up using standardised, inexpensive and reliably operating drive systems.

The objective of the invention is also achieved by the features set out in claim 75. The surprising advantage of the features defined in the characterising part of claim 75 is that during an adjustment procedure in the direction of the length and/or inclination, high forces and energies are released if there is a forceful impact in the end positions and these can be absorbed by the resilient element by elastic deformations in one or more spatial directions. Another advantage is the fact that the resilient element used as a damping and/or tensioning element on the one hand enables the base element to be returned to its non-clamped open position and on the other provides the damping element for absorbing the energy by means of a single component. This minimises the number of individual components and brings a considerable reduction in the cost of manufacturing a steering shaft adjustment unit of this type. Yet another advantage is the design of the cutout in the guide element, which transmits energy directly to the resilient element on impact and is simultaneously gentler on the construction. There is no need for damping elements in the region of the cutout of the bearing element, which simplifies the structural design. Furthermore, the steering shaft adjustment unit comprises few parts and can be assembled on the production line, which helps to keep manufacturing costs down.

The embodiment defined in claim 76 has an advantage insofar as the resilient element can be used as a damping element in various spatial directions.

The embodiment defined in claim 77 is of advantage because the guide element which serves several functions operates as a stop element for restricting the adjustment path and as a guide element in the cutout, and any energy released on impact with the end position is transmitted directly to the resilient element and to the base element.

As a result of the embodiment defined in claim 78, the guide element can be shifted into a position overlapping with certain regions of the base element, thereby enabling the amount of space needed to accommodate the guide elements, resilient element and base element to be reduced.

The advantage of an embodiment as defined in claims 79 to 82 is that the resilient element is fixedly retained by the groove and the shoulder, so that the resilient element is held in position even if high laterally acting forces occur.

Another embodiment, defined in claim 83, is of advantage because as the guide element hits one of the end positions of the cutout, the resilient element is deformed and the concave curved piece of the shoulder is brought into at least partial abutment with the convex curved piece of the guide element co-operating therewith, so that the energy acting as a pushing tension is absorbed in the resilient element. This enables forces in the longitudinal direction of the cutout to be absorbed by the resilient element without causing any wear on the resilient element. Another advantage is the fact that the guide element is held in position by the resilient element, even in a non-clamped open position, and is guided substantially without any clearance.

The embodiments defined in claims 84 and 85 enable standardised, inexpensive components to be used.

The invention will be explained in more detail below with reference to various examples of embodiments illustrated in the appended drawings.

Of these:

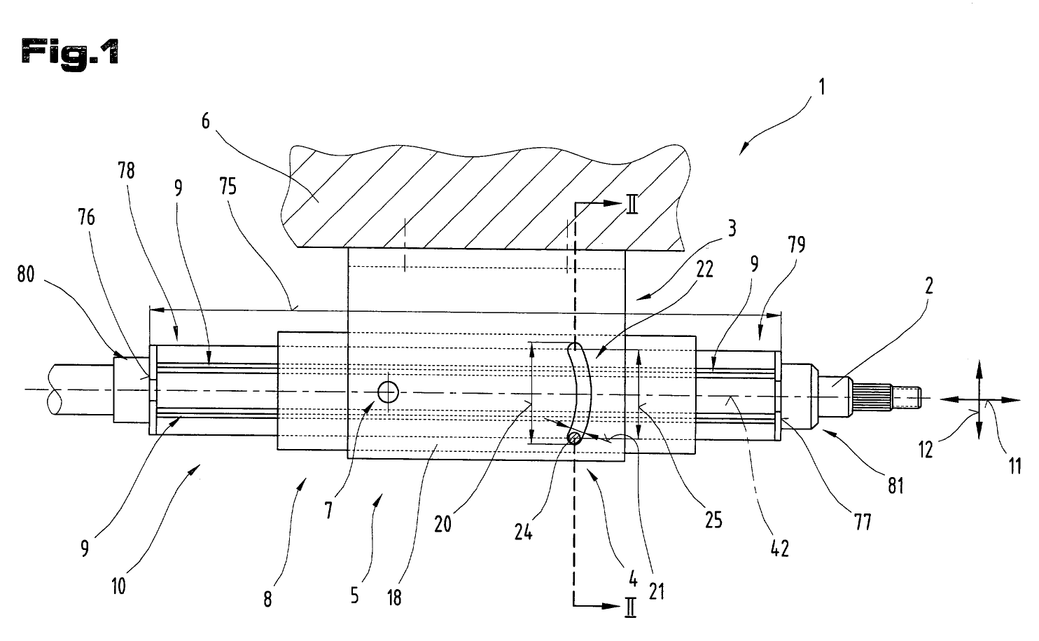

FIG. 1 is a simplified, schematic diagram showing a side view of the steering shaft adjusting unit proposed by the invention;

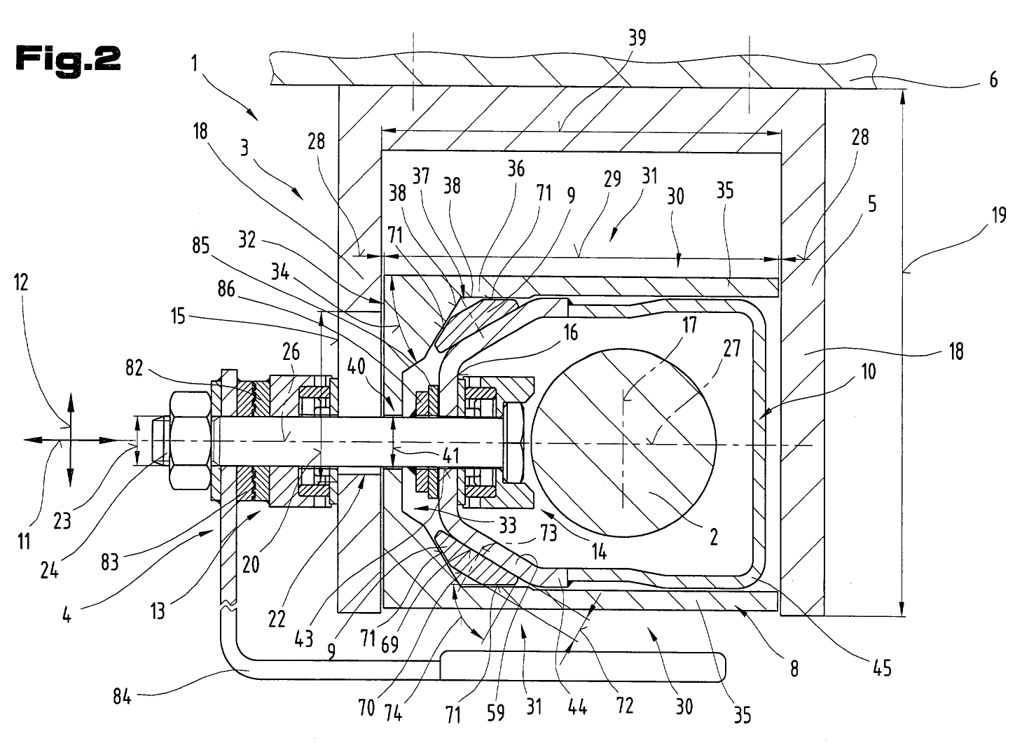

FIG. 2 is a front view of the adjusting and fixing mechanism, seen in section along the line II-II indicated in FIG. 1;

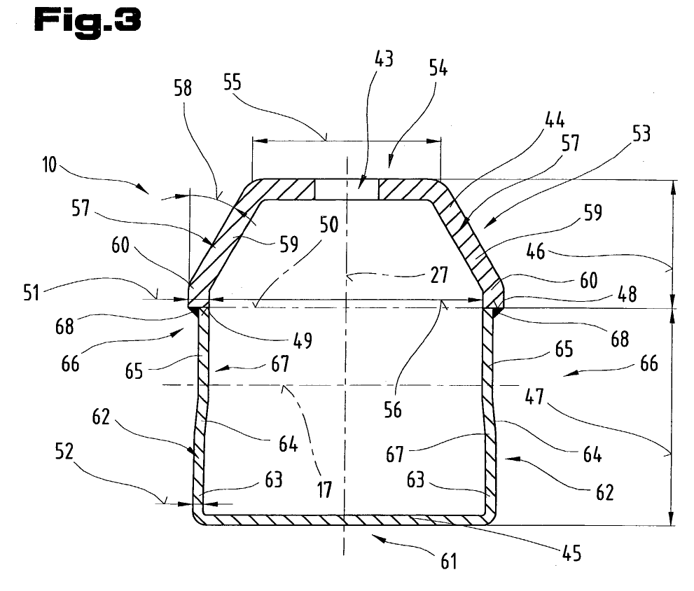

FIG. 3 is a schematic diagram showing a front view in section of a bearing element;

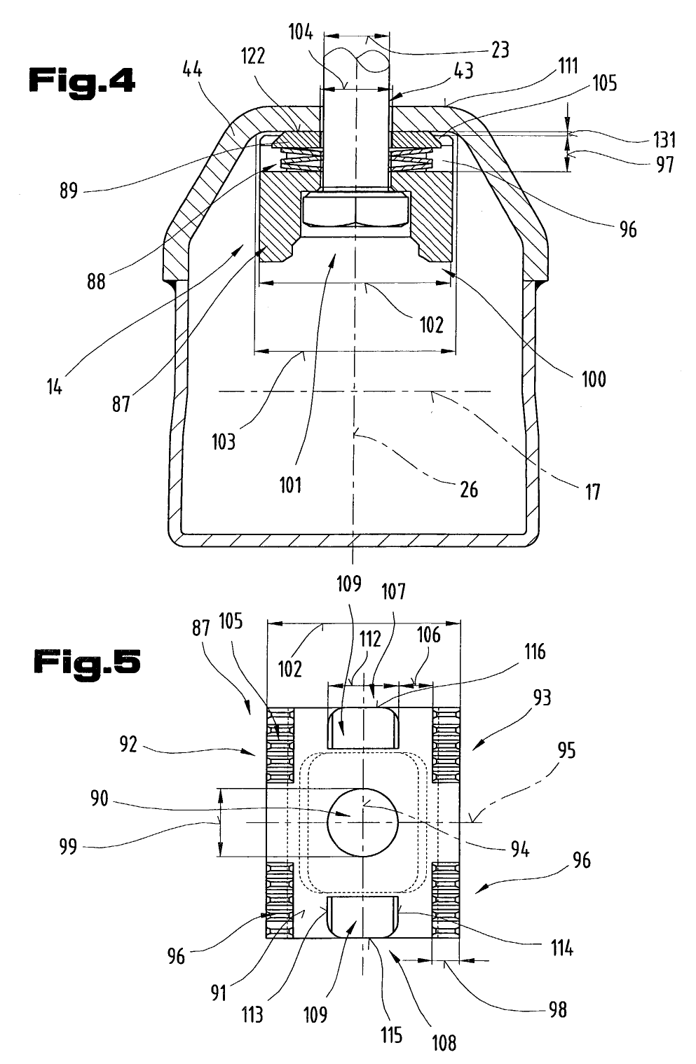

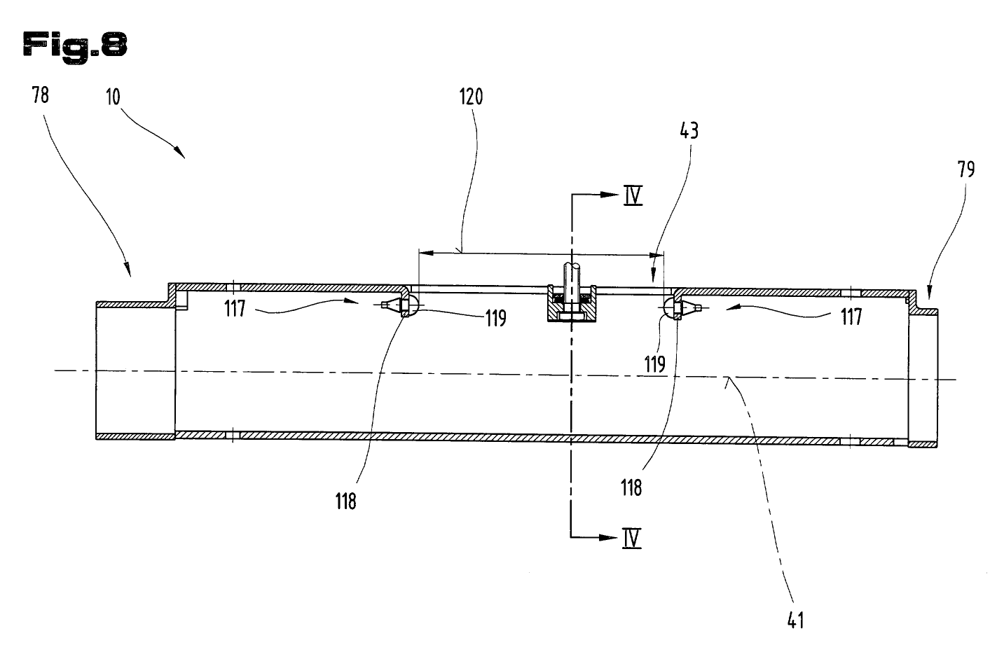

FIG. 4 is a front view showing a part-region of the fixing mechanism with the bearing element proposed by the invention, seen in section along the lines IV-IV indicated in FIG. 8;

FIG. 5 is a simplified, schematic diagram showing a plan view of a base element;

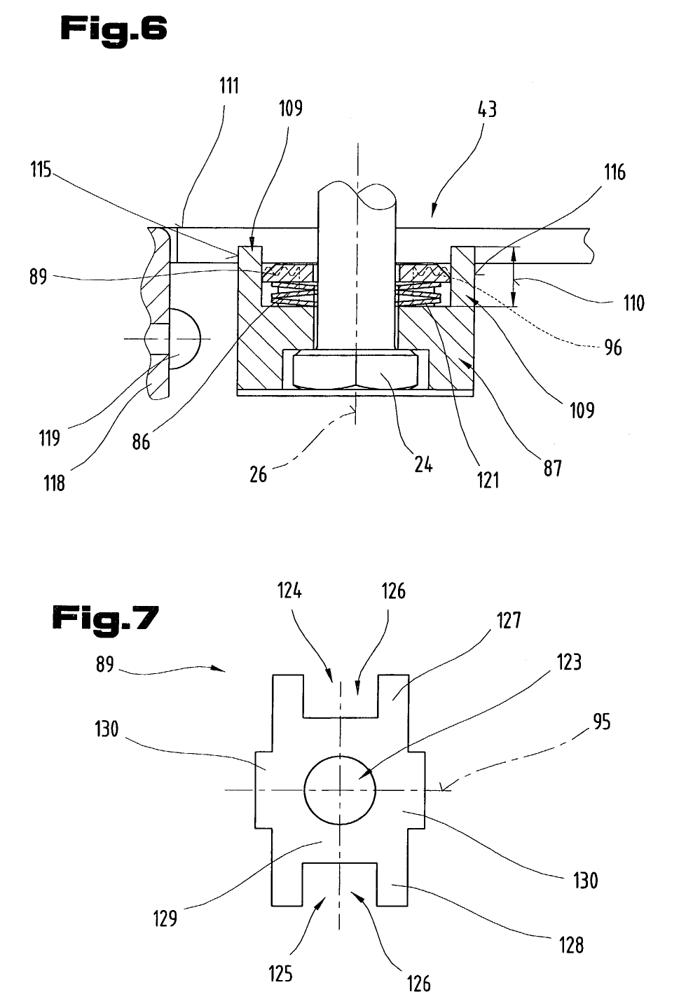

FIG. 6 is a simplified, schematic diagram showing a side view of a part-region of the fixing mechanism proposed by the invention and illustrated in FIG. 8, seen in section and on an enlarged scale;

FIG. 7 is a simplified diagram showing a plan view of a guide element;

FIG. 8 is a simplified diagram in section, showing a side view of the bearing element;

FIG. 9 is a front view showing a part-region of another embodiment of the fixing mechanism proposed by the invention, seen in section along the lie IV-IV indicated in FIG. 8;

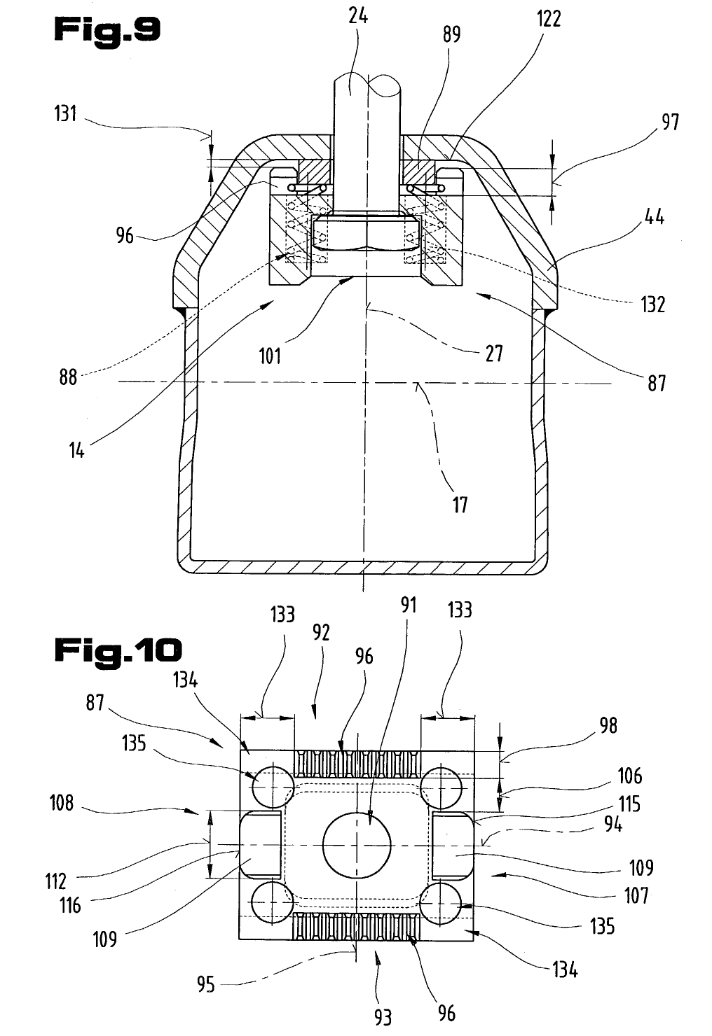

FIG. 10 is a highly simplified, schematic diagram showing a plan view of the base element;

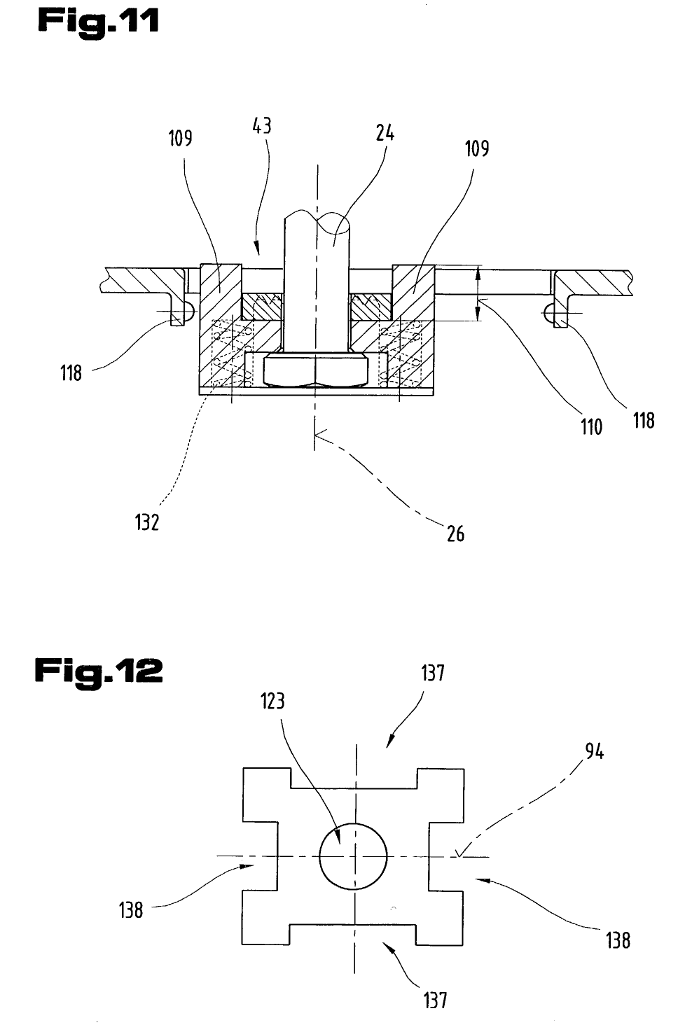

FIG. 11 is simplified diagram, in section and on an enlarged scale, showing a side view of a part-region of the fixing mechanism proposed by the invention and illustrated in FIG. 8;

FIG. 12 is a simplified diagram showing a plan view of the guide element;

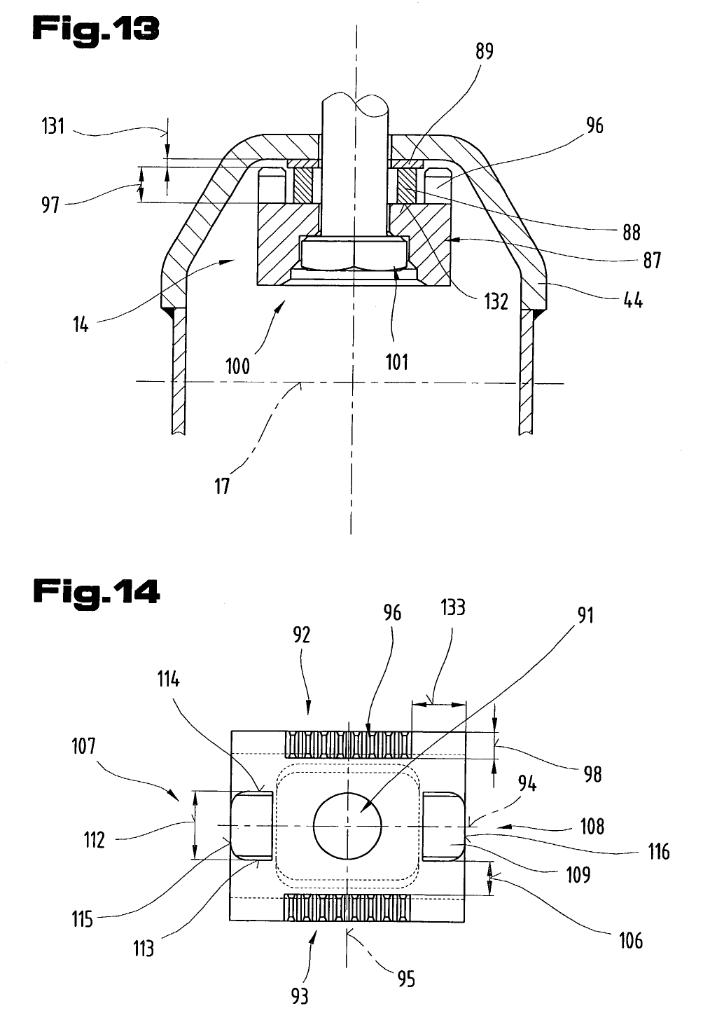

FIG. 13 is a front view, seen in section along the line IV-IV indicated in FIG. 8, showing a part-region of another embodiment of the fixing mechanism proposed by the invention;

FIG. 14 is a highly simplified, schematic diagram showing a plan view of the base element;

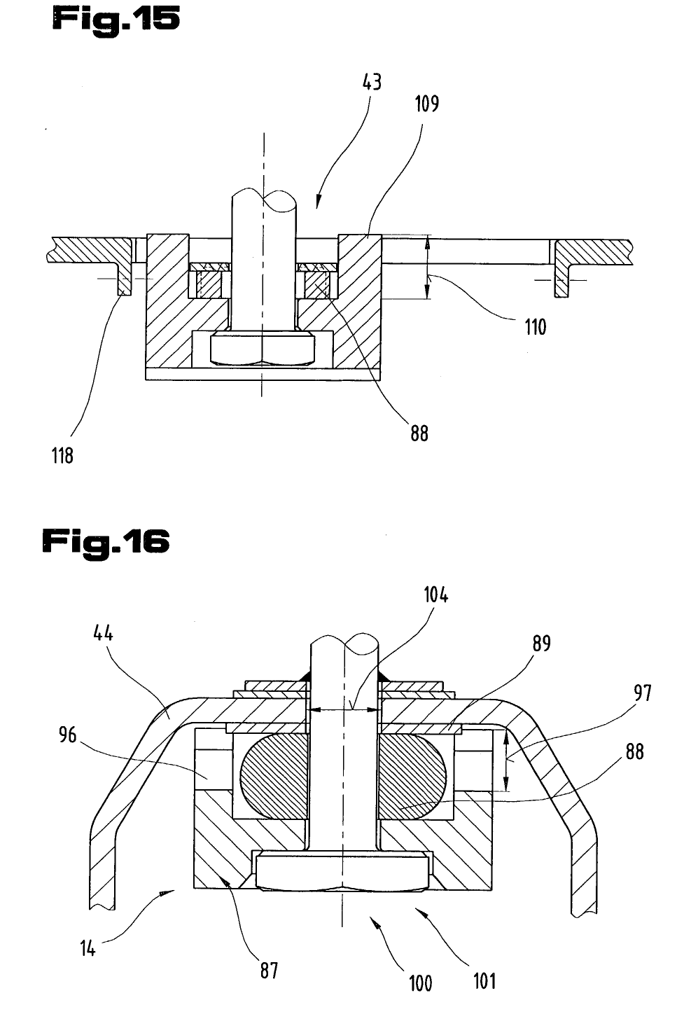

FIG. 15 is a highly simplified, schematic diagram, seen in section and on an enlarged scale, of a part-region of the fixing mechanism proposed by the invention and illustrated in FIG. 8;

FIG. 16 is a highly simplified, schematic diagram giving a front view in section of a part-region of another embodiment of the fixing mechanism proposed by the invention and illustrated in FIG. 1;

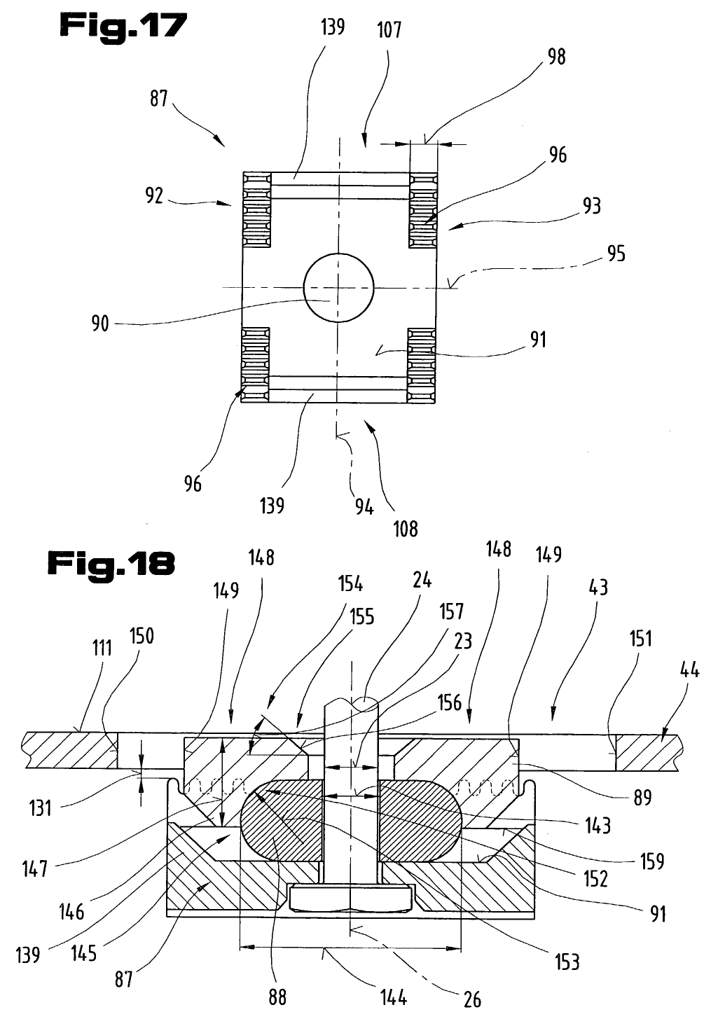

FIG. 17 is a highly simplified, schematic diagram showing a plan view of the base element;

FIG. 18 is a highly simplified, schematic diagram showing a part-region of another embodiment of the fixing mechanism proposed by the invention, seen in section and on an enlarged scale;

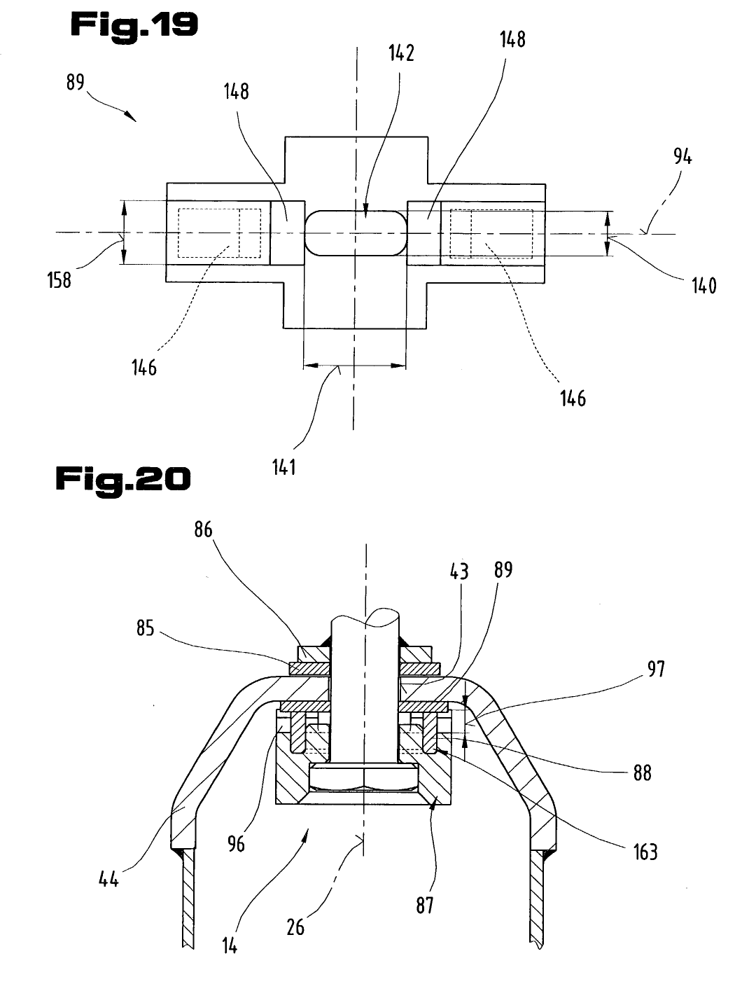

FIG. 19 is a simplified diagram showing a plan view of the guide element;

FIG. 20 is a highly simplified diagram giving a front view of a part-region of another embodiment of the fixing mechanism illustrated in FIG. 1, proposed by the invention, seen in section;

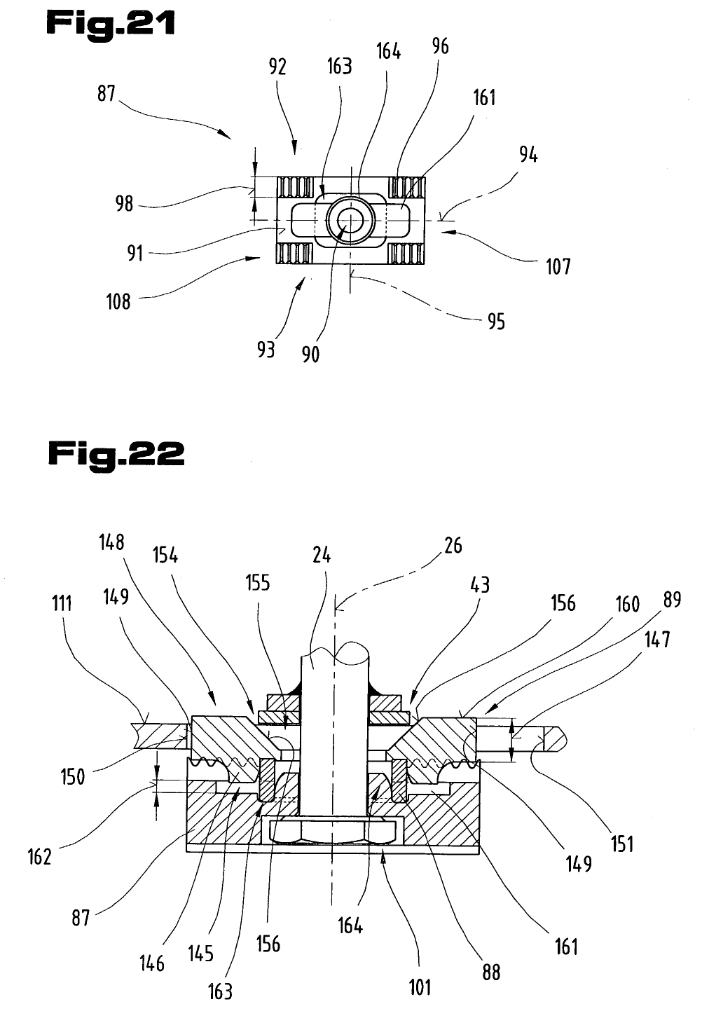

FIG. 21 is a highly simplified, schematic diagram showing a plan view of the base element;

FIG. 22 is a schematic diagram, in section and on an enlarged scale, giving a side view of a part-region of the fixing mechanism illustrated in FIG. 1, proposed by the invention;

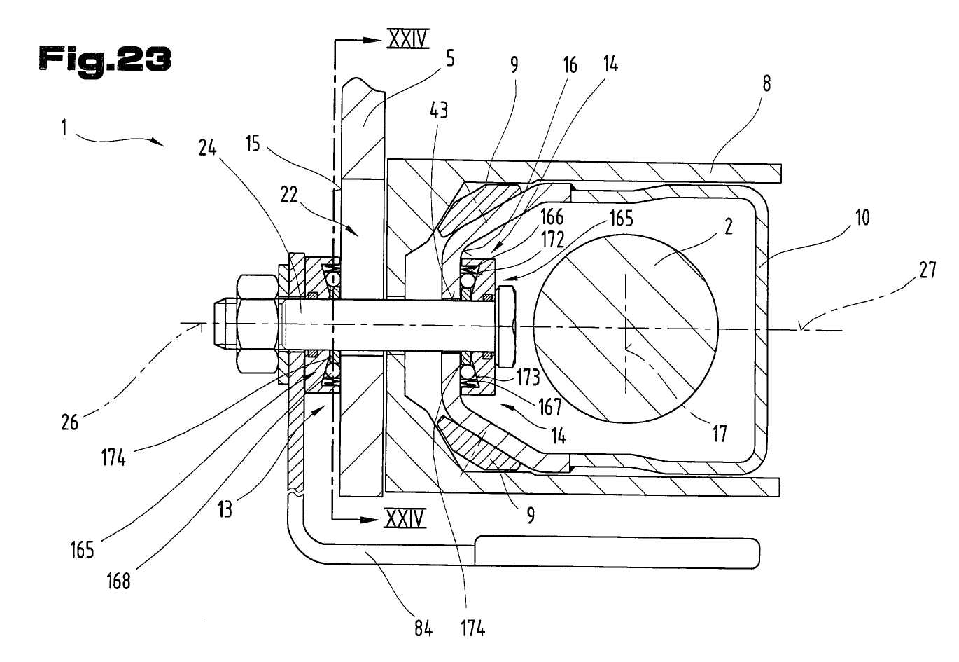

FIG. 23 is a front view of another embodiment of an adjusting and fixing mechanism as proposed by the invention, seen in section along the line II-II indicated in FIG. 1;

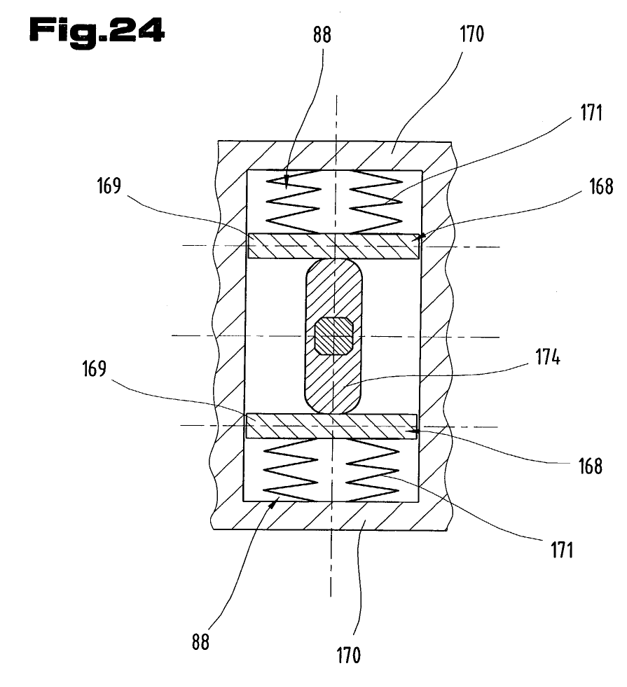

FIG. 24 is a highly simplified diagram showing a side view of a part-region of the fixing mechanism illustrated in FIG. 23, seen in section along the line XXIV-XXIV;

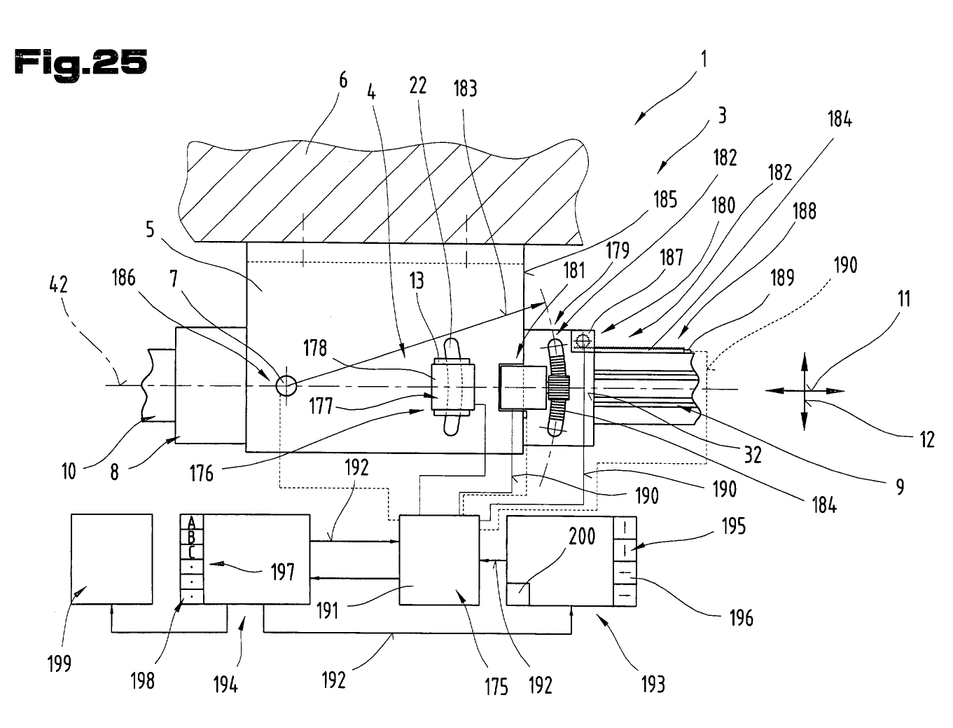

FIG. 25 is a highly simplified, schematic diagram showing a side view of another embodiment of the steering shaft adjustment unit proposed by the invention.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

It should be pointed out that all the drawings show a non-clamped open position.

FIGS. 1 to 3 illustrate a steering shaft adjusting unit 1 for adjusting and fixing a steering shaft 2, which is fitted with an adjusting mechanism 3 as proposed by the invention and a fixing system 4 as proposed by the invention co-operating therewith. The steering shaft adjusting unit 1 is made in several parts, preferably in a modular design, and consists of a preferably U-shaped mount 5 forming a locking mechanism and joined to the bodywork 6 and a substantially U-shaped or trapezoid-shaped profiled piece 8 mounted so as to move in a pivoting action on a pivot axis 7 within the U-shaped mount 5, and, by means of a guide element 9 such as guide strips, guide depressions, guide arms, guide blocks, etc., guiding an internally lying bearing element 10 which is provided in the form of the steering column tube, for example, in which a length-adjustable steering shaft 2 known from the prior art is held in position. The advantage of this arrangement is that the mount 5, the profiled piece 8 and the bearing element 10 are encased in at least certain regions in a housing-type arrangement, which largely protects the steering shaft adjusting unit 1 from detrimental external influences without having to use any additional structural features. Encased by the profiled piece 8 and the U-shaped mount 5, the bearing element 10 can be manually adjusted and/or pivoted, as indicated by double arrow 11 and double arrow 12, by means of the adjusting mechanism 3 in the direction of the longitudinal extension of the bearing element 10 and transversely to the longitudinal extension and can be fixed in the adjusted position, so that the steering wheel can be adjusted to an individual operating position to suit the driver, as illustrated in the embodiment depicted as an example here. The fixing system 4 is provided in the form of at least one, preferably two fixing mechanisms 13 and 14, which engage on a surface 15 of the U-shaped mount 5 and/or on a surface 16 of the bearing element 10 lying opposite it, and fix a set position between two adjustment procedures.

For practical purposes, two legs 18 extending parallel with a mid-line 17 of the steering shaft 2 perpendicular to the longitudinal extension and of a height 19 receive the profiled piece 8 disposed between them and pivotably mounted on the pivot axis 7 and the bearing element 10 guided by the profiled piece 8 in order to make the length adjustment. One of the two legs 18 has a cutout 22 with a length 20 and a width 21 extending in a convex arrangement directed transversely to the longitudinal direction of the steering shaft 2, in particular the pivot axis 7, permitting an adjustment as indicated by double arrow 12. The width 21 of the cutout 22, which is slit-shaped for example, is slightly bigger than a tensioning element 24 disposed transversely to the longitudinal direction of the steering shaft 2 having a diameter 23, which receives the fixing system 4. By preference, the tensioning element 24 is provided in the form of a tension bolt, etc., secured to prevent if from rotating. Accordingly, the fixing mechanisms 13, 14 are retained in a position in which they are prevented from turning relative to the tensioning element 24. The cutout 22, which may be rectangular, slit-shaped, etc,. spaced at a distance apart from the pivot axis 7, bounds an adjustment path 25 resulting from the difference in the length 20 and the diameter 23, which may be selected accordingly depending on the intended purpose. A mid-line 26 of the tensioning element 24 extends congruently with an axis of symmetry 27 formed by the profiled piece 8 and the bearing element 10 and marks the initial position of the adjusting mechanism 3 and the fixing system 4 proposed by the invention.

The substantially U-shaped profiled piece 8 received by the U-shaped mount 5 within the height 19 and preferably pivotably mounted on the pivot axis 7 so as to rotate by 90° relative thereto, is held in position at a distance 28 from the two oppositely lying legs 18 of the mount 5. Two side legs 30 formed by the profiled piece 8 and having a height 29 are provided, extending on an external face 31 parallel with the axis of symmetry 27, and, together with a side leg 30 closing the base 32 form a U-shaped contour. The height 29 projects from the base 32 in the direction of the axis of symmetry 27. An internal face 33 is formed by the side legs 30, which extend in the direction of the mid-line 17 in a tapering arrangement and then widen, the farther the distance, at an angle 34 and terminate at end parts 35 disposed parallel with the axis of symmetry 27. Mounted in an angled intermediate part 36 of the side legs 30 is a guide mechanism 37, which may have the shape of an equilateral triangle, forming a support and/or guide surface 38 of guide tracks, in particular lateral and height guide tracks, for sliding and supporting the bearing element 10. An angle subtended in a cross-sectional plane between support and/or guide surfaces 38 is greater than 90°. The sum of the two distances to the two oppositely lying legs 18, together with the height 29, form what constitutes an opening width 39 for the mount 5. The profiled piece 8 received by the tensioning element 24 has a bore 40 with a diameter 41 in the base 32 in the direction of the axis of symmetry 27. Positioned inside the profiled piece 8 and guided in the direction of the steering shaft mid-line 42 and in the direction of the mid-line 17 and axis of symmetry 27, the bearing element 10 is made in two parts, for example, consisting of a first part 44 with a cutout 43 and another part 45 lying opposite it.

The cutout 43 is arranged parallel with and extends in the direction of the steering shaft mid-line 42. End faces 48 and 49 formed by the first part 44 having a height 46 and the other part 45 having a height 47 form an imaginary dividing plane 50 extending parallel with the mid-line 17, the axis of symmetry 27 being arranged perpendicular thereto.

For practical purposes, the first part 44 having the height 46 is designed with a thicker wall thickness 51 and a shorter height 46 than a wall thickness 52 and height 47 of the other part 45. The first part 44 has a trapezoid-shaped cross section 53, for example, a width dimension 55 on a base 54 being smaller than a width dimension 56 arranged parallel with the width dimension 55 in the region of the dividing plane 50. The parts of side legs 57 between the base 54 of the first part 44 and the imaginary dividing plane 50 are inclined towards one another in a direction of the height 46 and widen the greater the distance from the base 54 at an angle 58 and form intermediate parts 59 and end parts 60 extending parallel with the axis of symmetry 27, between which the width dimension 56 extends. The parts of side legs 62 between a base 61 of the other part 45 and the imaginary dividing planes 50 extend parallel with the axis of symmetry 27 in the direction of the height 47 in initial parts 63 and adjoin an intermediate part 64 with a slight taper, which are then followed by end parts 65 parallel with the axis of symmetry 27. The wall thicknesses 51 and 52 formed by the first part 44 and the other part 45 form a protrusion on the external face 66 and/or on the internal face 67 in the region of the imaginary dividing plane 50.

The wall thickness 52 may be slimmer than and/or the same as and/or thicker than the wall thickness 51 of the first part 44. The variation of the wall thickness 51 will naturally also apply accordingly. As may be seen from FIG. 3, the differing wall thicknesses 51, 52 result in a hollow throat 68 and a joining point, facilitating the tasks involved in assembly. The intermediate parts 64 formed by the first part 44, facing away from one another, receive the guide elements 9 necessary to guide the profiled piece 8, which is of a substantially trapezoid design and has two spaced apart, parallel end faces 69, 70, those having the bigger end face 69 being joined to the intermediate part 59. The guide elements 9 may be connected to the bearing element 10 by means of screws, adhesive, seams, welding, for example, and with all other known jointing and fixing processes. Support and guide surfaces 71 formed between the end faces 69 and 70 initially extend parallel with an axis of symmetry 73 in the direction of a height. 72, adjoining a region inclined at an angle 74 thereto. The support and guide surfaces 71 form the seat for the profiled piece 8 between the mount 5 and the bearing element 10 disposed inside.

The angled design of the support and guide surfaces 71 affords an accurate guide direction and hence positioning and additionally provides a slightly dimensioned clearance, necessary for the longitudinal displacement the profiled piece 8 and the bearing element 10. All known guide elements may be used for the guide element 9, for example hard metal strips, etc..

As may be seen form FIG. 1, the extracted bearing element 10 projects beyond the profiled piece 8 and the mount 5 by a length 75 and, on two opposing end-side end faces 76 and 77 has bearing receiving points 78 and 79, which form the bearings 80 and 81 for the steering shaft 2. Naturally, the mount 5 of the profiled piece 8 and the bearing element 10 may be of any length. For example, the length of the mount 5 and/or the bearing element 10 may be shorter than and/or the same as and/or longer then the length of the profiled piece 8.

In another embodiment, the bearings 80 and 81 are formed directly by the bearing element 10. The fixing system 4 is formed by two oppositely lying fixing mechanisms 13, 14 displaceable relative to one another, which overlap with the surface 15 of the U-shaped mount 5 and the surface 16 of the bearing element 10 in certain regions, two meshing disc cams 82 and 83 which rotate relative to one another, a lever 84 rotatably or pivotably mounted on the tensioning element 24 and the co-operating tensioning element 24 disposed at 90° to link said parts with a plastics disc 85 passing across or overlapping with the base 54 of the bearing element 10 and a parallel sheet metal disc 86 arranged opposite, which is joined to the tensioning element 24 so as to be prevented from displacement. Naturally, the two fixing mechanisms 13 and 14 may also be ranged rotated by 90° relative to one another.

The fixedly mounted disc cam 82 lying closer to the fixing mechanism 13 is advantageously integrally formed on and with the fixing mechanism 13 and/or is joined thereto. The same also applies to the disc cam 83, which is joined to the lever 84 so as to be prevented from turning and/or is integrally formed thereon. Naturally, the disc cam 82 and/or 83 may be joined to the fixing mechanism 13 and/or to the lever 84 by any joining means known from the prior art, for example by welding, adhesive, soldering, etc.. The disc cams 82 and 83, which are rotatably displaceable relative to one another when the lever 84 is pivoted, cause a relative displacement of the fixing mechanisms 13 and 14. Disc cams 82 and 83 of this type which generate a substantially perpendicular adjustment path in the circumferential direction are already widely known from the prior art. The connection between the sheet metal disc 86 and the tensioning element 24 may be a friction-fit and/or positive-fit connection. Naturally, it would also be possible to use only one disc cam 82 or 83 co-operating with a disc-shaped component, in which case the disc cam 82 or 83 is non-rotatingly joined to the lever 84 and will engage on an end face directed towards the disc-shaped component. Rotating or pivoting the lever 84 causes a relative displacement of the component and the cam disc 82 or 83. The height of the sheet metal disc 86 and the plastics disc 85 are selected at a height that will leave a sufficient distance between the base 32 and the profiled piece 8.

The embodiment of the bearing element 10 illustrated here is but one possible embodiment and it would naturally be possible to use all possible embodiments that would work with the design of the first part 44 and/or the other part 45. The bearing element 10 may be provided in the form of a single-part or multi-part, inherently closed or open body. The same naturally applies to the profiled piece 8 and the mount 5, which might comprise a tube with a circular and/or multi-cornered, closed or open cross section in a receiving plane perpendicular to its longitudinal extension. This design advantageously offers a small and compact structure whilst simultaneously affording a high degree of stiffness, a low weight and an exact fixture and is gentle on the construction.

FIGS. 4 to 8 illustrate an embodiment of the fixing mechanism 13 and/or 14, consisting of a preferably rectangular base element 87, at least one resilient element 88 to which force is applied and, arranged above it, at least one guide element 89 sliding above and overlapping with a part of the base 54 of the bearing element 10.

Naturally, the resilient elements 88 of the fixing mechanisms 13 and/or 14 may have the same or a different spring stiffness, in which case the fixing process may take place simultaneously with or alternatively consecutive to operating the lever 84 from a non-clamped open position into a fixing closed position. On a surface 91 at two opposing ends 92 and 93, the base piece 87 with a bore 90 lying at the centre has two parallel, spaced apart pairs of clamping elements 96, extending in the direction of the longitudinal mid-line 94 and spaced apart by a mid-line 95, which have a height 97 and a width 98.

As a result, in a non-clamped open position, the guide elements 89 of the fixing mechanisms 13 and/or 14 are guided via the resilient elements 88 without any clearance on the surfaces 15 and/or 16 of the mount 5 and/or the bearing element 10 facing them, whilst the clamping elements 96 of the fixing mechanisms 13 and/or 14 extend at a distance apart from the surfaces 15 and/or 16 facing them.

In a locked position, the clamping elements 96 are applied with a pressing force, pre-settable by means of the spring stiffness of the resilient elements 88, against the surface 15 of the mount 5 and/or the surface 16 of the bearing element 10.

The bore 95 integrated in the centre of the base element 87 perpendicular to the surface 91 has a diameter 99 matching the diameter 23 of the tensioning element 24. Disposed on the underside 100 is a recess 101 designed to match the dimensions of the tensioning element 24 to receive the tensioning element head such that it is prevented from turning. A width 102 of the base element 87 is slightly smaller than a width dimension 103 of the first part 44 of the bearing element 10 incorporating the recess 43 which has a width 104. The clamping elements 96 disposed perpendicular to the surface 91 have teeth 105 directed towards the surface 16 of the bearing element 10 and/or the surface 15 of the mount 5, which extend parallel with the mid-line 95 across the length of the clamping elements 96 guaranteeing that a set position can be fixed. Positioned in a space 106 between the two oppositely lying pairs of clamping elements 96 on the two oppositely lying end faces 107 and 108 in the longitudinal direction of the mid-line 94 are two mutually facing, substantially U-shaped guide and/or stop elements 109 with a height 1 10, which project into the cutout 43 or which project beyond a top edge 111 of the first part 44 of the bearing element 10. Naturally, it would be possible to provide only one guide and/or stop element 109 on the base element 87. The height 97 of the clamping elements 96 is shorter than the height 110 of the guide and/or stop elements 109 standing perpendicular to the surface 91 and their width 112 is slightly smaller than the width 104 of the cutout 43. The end faces 113 and 114 extending parallel with the longitudinal mid-line 94 and across the height 10 provide a lateral guiding action during an adjustment procedure. The guide and/or stop elements 109 having the height 110 project beyond the height 97 of the toothed elements 96 and form two oppositely lying, end-side stop surfaces 115 and 116 parallel with the mid-line 95, which abut on vertically positioned tabs 118 provided with a bore 117 in the bearing element 10 underneath the cutout 43 for receiving damping elements 119 and thus define the adjustment path 120.

As may be seen more clearly from FIG. 8, when the damping elements 119 are fully compressed, the adjustment path 120 is slightly lengthened, in effect by the horizontal dimension of the height of the damping element 119. The two oppositely lying edges formed at either side by the cutout 43 serve as end stops so that the stop surfaces 115 and 116 restrict the adjustment path 120 due to deformation of the damping element 119.

The base element 87 may be designed as a single part and/or as multiple parts. For practical purposes, it is made from a single part, consisting of one or more clamping elements 96 and one or more guide and/or stop elements 109, which reduces the number of individual parts. If provided as a multi-part design, the clamping elements 96 and the guide and/or stop elements 109 are joined to the base element 87 using any standard joining options such as adhesive, rivets, screws, welding, etc.

The clamping elements 96 may naturally also have a knurled surface, etc., or a surface with a pronounced roughened structure, which will provide a reliable means of preventing slipping. Furthermore, the teeth 105 may be oriented on any of the sides. The base element 87 may be made from a metal other than iron and/or iron metals and/or alloys and/or plastics, etc.. For practical purposes, an aluminium alloy is used, which is subsequently machined, resulting in a low component weight whilst affording sufficient strength.

In the embodiment illustrated as an example here, the resilient element 88 is a spring 121, biassed in the direction of the mid-line 26, and for practical purposes is a plate spring, which generates high spring forces and hence high biassing forces whilst requiring only a small amount of space. Naturally, it would be possible to use all other known materials which exhibit a similar characteristic curve behaviour.

The substantially H-shaped guide element 89 provided with a bore 123, mounted above and in contact with the resilient element 88 by means of a bottom edge 122, has a recess 126 receiving the guide and/or stop elements 109 on the two oppositely lying end faces 124 and 125, having oppositely lying side webs 127 and 128 at either side positioned within the space 106 and which form an expediently flat transition with the end faces 107 and 108 of the base element 87. In the region of an intermediate web 129 lying parallel with the mid-line 95 and provided with the bore 123, several integrally formed wing elements 130, which are rectangular in shape for example, and project beyond the side webs 127 and 128 are provided on either side, which are positioned in the spaced region between the pairs of clamping elements 96. The guide element 89 essentially constitutes the negative part to the base element 87, which is designed to have a slight clearance around the sides.

The guide element 89 is made from a different type of material than the bearing element 10, which exhibits good sliding properties with a simultaneously low wear, such as copper-tin alloys, aluminium alloys, for example, in particular plastics. The guide element 89 is also used to provide the required damping in the end positions during the adjustment process, thereby preventing any unpleasant noise or a high degree of wear on the individual components.

Operation of the Adjusting and Fixing Mechanism:

When a position is to be fixed, the clamping elements 96 of the fixing mechanisms 13 and/or 14, which are displaceable relative to one another in the longitudinal extension of the tensioning element 24, are adjusted by operating the lever 84 and a stroke 131 is covered by the distance between the bottom edge 122 and the clamping elements 96, which shortens the pretensed spring height and simultaneously lifts the clamping elements 96 in the direction of the mid-axis 26. As a result, the fixing mechanisms 13 and/or 14 are moved with the clamping elements 96 from a non-clamping open position into a fixing locking position and fix the set position or disposition of the steering shaft 2. In the fixing locked position, the bearing element 10 and the profiled piece 8 are held in position relative to the mount 5 and/or are at least slightly tensed. This being the case, the mutually facing side faces of the leg 18 of the mount 5 and the side faces of the base 32 of the profiled piece 8 are at least partially supported against one another and thus cause a friction connection between the leg 18 of the mount 5 and the base 32 of the profiled piece 8 depending on the surface properties of same. At least one of the surfaces may have a more pronounced surface roughness, which will advantageously improve the friction connections, so that the components such as the resilient elements 88, base elements 87, etc., of the fixing mechanisms 13 and 14 can be made to smaller dimensions in terms of their structural design.

From clamped state, the fixing action is released again due to the upward movement of the clamping elements 96 and due to the simultaneous increase in the spring height.

In the released state, the biassing force generated by the spring 121 causes a minimum resistance to displacement so that the user can fix the adjusted operating height without having to apply a counter-force.

In another embodiment, not illustrated, a lateral shoulder is mounted on the mount 5 standing proud of the surface 15, for example, which produces a positive-fit connection with the clamping elements 96 of the fixing mechanism 13, in particular the teeth 105 thereof, in the clamped state. During an adjustment manoeuvre into a non-clamped position, the teeth 105 of the clamping elements 96 are lifted out of or raised from the teeth of a projection, enabling an adjustment in the height direction and in the longitudinal direction.

Any combination of the positive-fit and/or friction-fit fixture may be used to fix the mount 5 and the fixing mechanism 13 and/or the bearing element 10 and the fixing mechanism 14. For example, it would be possible to provide at least one moulded element on the surface 15 and/or 16 of the mount 5 and/or the bearing element 10, in particular a projection fitted with teeth so as to provide a positive meshing of the teeth 105 of the clamping elements 96 with the teeth of the projection in the locked position.

This operating principle is illustrated by the embodiments shown in FIGS. 9 to 24.

FIGS. 9 to 12 show another embodiment of the fixing mechanism 13, consisting of the base element 87, in which four springs 132, in particular compression springs, are provided as the resilient element 88, and a guide element 89 mounted on top and provided with four nubs for centring the springs 132.

The base element 87, with the bore 91 lying at the centre and the cutout 101 disposed underneath, has two spaced apart clamping elements 96 with the height 97 and the width 98 on the two oppositely lying sides 92 and 93 in the direction of the longitudinal mid-line 94 and extending continuously at a distance 133 from the two end faces 107 and 108.

As with the drawings described above, the base element 87 has two mutually facing, substantially U-shaped guide and/or stop elements 109 with the height 110 in the space 106 left between the two oppositely lying clamping elements 96 and disposed parallel with the mid-line 95. As described above, the height 100 of the guide and/or stop elements 109 optionally projects beyond a cutout 43 and, in conjunction with the width 112 thereof, acts as a lateral guide. The guide and/or stop elements 109 with the height 110 project beyond the height 97 of the toothed elements 96 and form the oppositely lying end-side stop surfaces 115 and 116 parallel with the mid-line 95, which abut with the tab 118 provided with the bore 117 in the bearing element 10 positioned vertically underneath the cutout 43 for receiving damping elements 119 and thus defining the adjustment path 120.

At the corner region 134 formed by the distance 133 and the sum of the space 106 and the width 98, the base element 87 having the width 102 has four bores 135 provided in the form of blind bores with a depth selected so as to accommodate the pre-tensioned springs 133. Around the outer periphery, the rectangular guide element 89 having the bore 123 has an off-set 137 and 138 on each side, the recesses 137 receiving the toothed elements 96 in the direction of the longitudinal mid-line 94 being longer in length than the recesses 138 receiving the guide and/or stop elements 109 having the width 112. When an adjustment is made, the guide element 89 provides the requisite damping and is therefore able to prevent any unpleasant noise and additional wear on the individual components during the adjustment.

FIGS. 13 to 15 illustrate another embodiment of the fixing mechanism 13 and 14 proposed by the invention, consisting of the base element 87, the resilient element 88 and the substantially H-shaped guide element 89 with the bore 123 disposed above it. The base element 87, with the bore 91 lying at the centre and the cutout 101 disposed on the underside 100, has two clamping elements 96 with the height 97 and the width 98 on the two oppositely lying sides 92 and 93 extending continuously at a distance 133 from the two end faces 107 and 108. As with the drawings described above, the base element 87 has two mutually facing, substantially U-shaped guide and/or stop elements 109 with the height 110 in the space 106 left in the direction of the longitudinal mid-line 94 between the two oppositely lying clamping elements 96 and disposed parallel with the mid-line 95. As also described above, the height 110 of the guide and/or stop elements 109 optionally projects beyond the top edge 111 and, in conjunction with the width 112 thereof, acts as a lateral guide. The guide and/or stop elements 109 with the height 110 project beyond the height 97 of the toothed elements 96 and form end-side stop surfaces 15 and 116 which abut with the tabs 118 provided with the bore 117 in the bearing element 10 positioned vertically underneath the cutout 43 for receiving damping elements 119 and thus define the adjustment path 120.

In the clamped state, the resilient element 88 disposed above the base element 87 and having a spring stiffness is compressed more or less by the stroke 131 and when relaxed is able to rebound in accordance with the behaviour of a spring characteristic curve. The H-shaped guide element 89 may be made from a single part or from several parts.

FIGS. 16 to 19 illustrate another embodiment of the fixing mechanism 13 and 14 proposed by the invention, consisting of the base element 87, the resilient element 88 and the guide element 89. On the surface 91, the base element 87 with a bore 90 lying at the centre has two clamping elements 96 with a height 97 and a width 98 spaced apart about a mid-line 95 on the two oppositely lying sides 92 and 93 in the direction of the longitudinal mid-line 94 and, extending between the clamping elements 96 on the two oppositely lying end faces 107 and 108 of the surface 91 of the base element, complementary wall parts 139 inclined at an angle to one another extending in the direction of the height 97 of the clamping elements 96 forming a smaller cross-sectional surface on the surface 91. As described above, the cutout 101 for receiving the head of the tensioning element 24 is also provided on the underside 100. The guide element 89 mounted above the resilient element 88 has a cutout 142 lying at the centre with a width 140 and a length 141, in particular an oblong orifice, slit, etc., and receives a resilient element 88 with a spring constant encasing the diameter 23 of the tensioning element 24, in particular an O-ring, rubber bead or any other resilient elements 88 known from the prior art which are capable of permitting deformation on all sides when subjected to a load. The resilient element 88 has an internal diameter 143 matching the diameter 23 of the tensioning element 24 and an external diameter 144 projecting beyond the width 140 of the cutout 142 and is received by an underside 145 oriented in the direction of the base element 87. The resilient element 88 may be of any possible shape, for example rectangular, square, etc., and for practical purposes may be round.

As may be seen from FIG. 18, the guide element 89 is provided with two oppositely lying projections 146 on the underside 145, positioned in the longitudinal extension thereof in a space corresponding to the external diameter 144, which project beyond the resilient element 88 by the half diameter. A total height 147 of a guide and stop element 148 formed by the guide element 88 projects at least into the cutout 43 of the first part 44 and, in conjunction with the two oppositely lying side faces thereof parallel with the mid-line 26, forms stop surfaces 149, which co-operate alternately with the oppositely lying end positions 150 or 151 of the cutout 43. The resultant contour of the underside 145 between the mid-line 26 and the stop surfaces 149 is constituted by an initial region directed towards the tensioning element 24 and extending parallel with the top edge 111, which merges into a bent curved piece 152, the radius 153 of which is approximately half the diameter of the resilient element 88, followed by a horizontal intermediate region, which adjoins an angled end region. A top face 154 lying opposite the underside 145 has a substantially trapezoid-shaped opening 155 about the mid-axis 26, with a larger cross-sectional surface in the direction remote from the base element 87, the angled legs 156 of which rise at an angle 157 directly in the region of the cutout 142 and two oppositely lying guide and stop elements 148 extending in the direction of the longitudinal mid-line 94 have a slightly smaller width 158 than the width 104 of the cutout 43 of the first part 44. Abutting with the large cross-sectional surface of the opening 155 on either side is a surface 159 parallel with the surface 91. As a result of the relative displacement of the base element 88 in the direction of the base 54 of the bearing element 10 and in the direction of the surface 15 of the leg 18, the resilient element, in particular the O-ring, is deformed and fixes the adjusted position of the steering shaft 2 relative to the mount 5.

When the steering shaft 2 is displaced in the longitudinal direction as indicated by double arrow 11, the kinetic energy generated when the guide and stop element 148 impacts with the stop surface 149 at one of the two end positions 150 or 151 is transmitted via the guide element 89 to the resilient element 88 and causes an elastic deformation. Since the energy generated is taken up and absorbed by the resilient element 88, there is no need to provide additional damping elements 119. Similarly, the forces and the associated kinetic energy generated when the steering shaft 2 is displaced transversely to the longitudinal direction as indicated by double arrow 12 are absorbed by the resilient element 88. The fact of providing the cutout 142 therefore enables the energy generated by the impact when the resilient element 88 is displaced relative to the base element 87 to be absorbed. This embodiment provides a damping action in all directions which means that an adjustment can be made without noise and which is gentle on the construction, whilst simultaneously requiring a small number of components, thereby reducing manufacturing costs in the broadest sense.

FIGS. 20 to 22 illustrate another embodiment of the fixing mechanism 13 and/or 14. The fixing mechanisms 13 and/or 14 consist of a, preferably rectangular, base element 87, a resilient element 88 and a guide element 89 mounted on top and projecting into the cutout 43 of the bearing element 10. Naturally, the guide element 89 forming the guide and stop elements 148 may project beyond the top edge 111. The base element 87 with a bore 90 lying in the centre and a, preferably rectangular, cutout 161 with a depth 162 on the surface 91 between the clamping elements 96 has two pairs of clamping elements 96 with the height 97 and the width 98 on the oppositely lying sides 92 and 93 extending parallel in the direction of the longitudinal mid-line 94 spaced at a distance apart about a mid-line 95.

On a groove 163 disposed in the base element 87 with the depth 162 in the direction of the cutout 101 sits a projection 164 disposed perpendicular to the surface 91 and projecting beyond the surface 91, which has the bore 90 in the centre, the external periphery being adapted to the resilient element 88. The cross section of the groove 163 and the shoulder 164 is formed by flanks or curved pieces extending towards one another in a convex arrangement in the direction of the clamping elements 96. In the direction of the base element 87, the guide element 89 has flanks and side surfaces widening in a convex arrangement so that the resilient element 88 received between the base element 87 and the guide element 89 causes a deformation due to the pushing tension which occurs in the resilient element 88 with the impact against one of the end positions 150 or 151, as a result of which, because of the special design of the cross section of the groove 163 and the guide element 89, the resilient element 88 conforms to or lies against the flanks and curved pieces, at least in certain regions. The advantage of this solution is that the deformed resilient element 88 is subjected to load uniformly across the entire cross section. Consequently, the resilient element 88 deformed by the pushing tension which occurs is brought to bear in certain regions on the shoulder 164 and the side faces of the projection 146 widening in a convex arrangement in the direction of the base element 87.

As a result of the groove-type recess in the guide element 89 and in the base element 87, in particular the groove 163, for receiving the resilient element 88 and another recess in the guide element 89 arranged opposite it, the resilient element 88 is held in position between the two components and is fixed by them.

Another possible embodiment of the groove 163 for receiving the resilient element 88 has a rectangular cross section.

The resilient element 88, in particular a plastics material with a defined spring stiffness, is held in position in the direction of the mid-axis 26 around the shoulder 164 lying in the centre and terminates more or less at the height 97 of the clamping elements 96. Any other elastic materials may be used for the resilient element 88, in particular synthetic materials, which exhibit a behaviour and properties of this type.

As may be seen more clearly from FIG. 22, the guide element 89 is provided with two mutually spaced apart, oppositely lying projections 146 on the underside 145, which preferably project by a half height beyond the resilient elements 88. A total height 147 of the guide element 88 projects into the cutout 43 of the first part 44 or projects beyond it and, in conjunction with the two oppositely lying guide and stop elements 148 extending parallel with the mid-line 26, forms the stop surface 149 for the respective oppositely lying end-side end positions 150 or 151 in the cutout 43. The contour of the underside 145 between the mid-line 26 and the stop surface 149 results from an initial region directed towards the tensioning element 24 extending parallel with the top edge 111, which merges into a region disposed perpendicular thereto, followed by a radius merging into a horizontal end region. As explained above, the top face 154 has the substantially trapezoid opening 155, with rising side legs 156 extending at an angle 157 and oppositely lying guide and/or stop elements 109 extending towards the longitudinal mid-line 94 which are slightly shorter in width 158 than the width 104 of the cutout 43. Adjoining the large cross-sectional surface of the opening 155 on either side is the surface 159 parallel with the surface 91.

The particular advantage of the embodiments illustrated in FIGS. 16 to 22 is that in the longitudinal direction of the tensioning element 24, the resilient element 88 acts as a tensioning element and in the direction extending transversely thereto acts as a damping element. When the fixing mechanisms 13 and/or 14 are moved into a locked position, the relative displacement of at least one fixing mechanism 13 or 14 in the direction of the surface 15 of the mount 5 and/or the surface 16 of the bearing element 10 causes the elastic resilient element 88 to deform in the longitudinal direction of the tensioning element 24 and fixes the adjusted position of the steering shaft 2. Consequently, the resilient element 88 acts as a tensioning element. Similarly, the resilient element 88 is able to absorb the forces which occur transversely to the tensioning element 24 when the fixing mechanism 13 or 14 hits one of the end positions 150 or 151, thereby acting as a damping element transversely to the longitudinal direction of the tensioning element 24 and/or optionally in the longitudinal direction of the tensioning element 24.

FIGS. 23 and 24 illustrate another embodiment of the fixing system 4 for the steering shaft adjusting unit 1. The fixing mechanisms 13 and 14, preferably rotated by 90° relative to one another, operated by means of the lever 84, consist of a body 165, symmetrical in rotation about a mid-line 26, which form two compartments 166, 167. For the clamping elements 168 arranged therein, provided as cylindrical or barrel-shaped rollers 169 in particular, elastic resilient elements 88 are provided, in particular compression springs 171, etc., mounted between a wall part 170 and the clamping elements 168. The clamping elements 168 may be fitted with clamping blocks of a shape substantially matching the cross-sectional shape of the compartments 166, 167. The two compartments 166, 167 tapering in a conical arrangement in mirror image towards one another have a tapered region of the cross section which tapers constantly relative to the surface 15 of the U-shaped mount 5 in the direction towards the mid-line 26, and are spaced apart from one another in the region of the smaller cross-sectional surface by a cylindrical transition region. Naturally, the conically tapering contour may also extend in the opposite direction. In the direction towards the mid-line 26, each of the two compartments 166, 167 has mutually inclined support surfaces 172, 173, by means of which a clamping action is produced between the clamping elements 168 and the surface 15 or the surface 16, due to the spring-biassing action acting in the direction towards the mid-line 26 and pushing the clamping elements 168 towards the conically tapering compartments 166, 167 to produce a clamping action. A lifting mechanism 174, mounted in the cylindrical transition region and directly on the tensioning element 24 so as to be integral therewith in rotation, in particular by a positive connection, friction fit, etc., engages directly on a side lying opposite the compression spring 171 and in the same line of action and, when the lever 84 is operated, generates a pressing force on the clamping elements 168, overcoming the spring action and the associated clamping action. The fixing mechanisms 13 and/or 14 are positioned so that they are unable to rotate. The lifting mechanism 174 of the fixing mechanism 13 and/or 14 may be of any design which will ensure a synchronous lifting of the rollers 169 and/or clamping blocks, etc., such as eccentrics, cam discs, etc.. The advantage of this embodiment is that if an arcuate curved piece is used as the operating means, the lifting mechanism 174 enables the steering shaft 2 to be uniformly adjusted and fixed without any backlash, obviating the need for additional cam discs 82, 83 between the lever 84 and the fixing mechanism 13. Furthermore, compared with the solutions known from the prior art, the forces needed for fixing purposes are much lower because they are generated by a system of forces created by spring forces and their individual force components, making it possible to use a construction with significantly thinner walls which is therefore less expensive.

FIG. 25 illustrates another embodiment of a steering shaft adjusting unit 1, which may advantageously be used in conjunction with both the adjusting mechanism 3 and/or fixing system 4 of the embodiment described with reference to FIGS. 1 to 24 but may also constitute an independent solution to the invention.

As explained at length with reference to FIGS. 1 to 3, etc., the steering shaft adjusting unit 1 is made up of an adjusting mechanism 3 and a fixing system 4, the steering shaft 2 of which is disposed so as to be slidable in the direction of the steering shaft mid-line 42 relative to a mount 5 mounted in a vehicle so as to be stationary, and is pivotable in at least a radial direction relative thereto. The profiled piece 8 at least partially encloses the bearing element 10 mounted on it so as to be longitudinally slidable by means of the guide elements 9, in which the length-adjustable steering shaft 2 is received by the bearing receiving points 78, 79 with a bearing 80, 81.

The schematic diagram illustrating this embodiment shows the automatically adjustable steering shaft adjusting unit 1 for adjusting a position in two spatial directions, whereby the adjusting mechanism 3 and the fixing system 4 can be operated by means of drive systems, as will be explained in more detail below, and the adjusting mechanism 3 automatically adjusts or adapts to a setting of the steering shaft 2 which can be pre-set, stored and retrieved by an operator and this adjusted position automatically fixed and held by the fixing system 4.

The fixing mechanism 13 and/or 14 is moved from a non-clamped open position into a fixing locked position which overcomes the action of the elastic resilient element 88 by means of at least one drive system 176 wired to a memory and control unit 175. An actuator drive 177 of the drive system 176 is preferably provided with threaded spindles having one, preferably two opposing threaded sections, in particular a precision thread spindle, with which an electric motor 178 of the drive system 176 is coupled so as to be integral in rotation therewith. Standardised electric motors 178 are used by preference, for example stepper motors, servo motors, etc., with an optionally integrated gear and/or brake arrangement and measuring device, which, due to its high degree of efficiency, will produce little wear for a high degree of positioning accuracy, whilst being very compact.

Advantageously, the drive system 176 used for fixing a set position may be small in terms of its rating and size, since the only forces to be overcome are the spring forces of the resilient elements 88. A counter threaded spindle with the same and/or a different thread pitch is used for the fixing mechanism 13; 14 in conjunction with the electric motor 178 so that the mid-axis of the drive shaft of the electric motor 178 preferably extends congruently with the mid-line 26 of the tensioning element 24. Consequently, when an adjustment is made transversely to the longitudinal extension of the steering shaft 2, the drive system 176 checked on the fixing mechanism 13 which can be coupled with the tensioning element 24 is also moved. For practical purposes, the electric motor 178 is fitted with a brake system, which may already be integrated therein or provided as an added component, which releases the retaining force or retaining torque generated via mechanical elements, for example, when electrical power is applied and permits an adjustment of the set position. The advantage of this is that even if the power supply is cut off, the retaining torque of the brake system can be relied on to hold the fixed locking position. Electric motors 178 fitted with brakes and/or gears of this type are already known from the prior art and do not fall within the scope of the present invention.

If a set position has to be changed, an adjustment may be made in two spatial directions by at least two other drive systems 179 and 180, in which case the retaining torque of the brake system of the drive system 176, in particular the electric motor 178, overcomes the spring forces expended by the resilient elements 88 in order to permit an adjustment in the direction of the steering shaft mid-line 42—indicated by double arrow 11—and/or in a direction disposed radially thereto—indicated by double arrow 12. The drive system 179, comprising an actuator drive 181 with gears, which is preferably retained on the mount 5, activates an actuator element 182 with a high torque and low speed, so that, in spite of the relatively high moments of inertia of the components to be displaced, compact actuator drives 181 with only low driving torques may be used. Drivingly linked to the electric motor 178 of the drive system 179 and 180, the actuator element 182 preferably forms a curved rack segment 184 with a pivot radius 183 which, for practical purposes is arranged on the base 32 of the profiled piece 8 at a distance from the front edge 185 directed towards the connecting piece of the steering wheel and in particular is screwed thereto. For practical purposes, the rack segment 184 is screwed on so that it can be easily replaced. The adjustment path may be determined by a measuring device already integrated in the actuator drive 181 and/or by a measuring device 186 which fixes the adjustment angle in the region of the pivot axis 7.

As may also be seen from FIG. 25, the profiled piece 8 has at least one other drive system 180 on the end region directed towards the connecting piece for the steering wheel, the actuator drive 187 of which is drivingly connected to a positioning element 188 mounted on the bearing element 10. The actuator drive 187 and the positioning element 188 thus also advantageously form a rack gearing system, in which a straight rack segment 184 meshes with an externally toothed end gear. The adjustment path in the longitudinal direction—indicated by double arrow 11—may be detected by the measuring device integrated in the actuator drive 187 or by an external measuring device 189 which is capable of detecting a relative displacement between the profiled piece 8 and the bearing element 10. The same naturally applies to the measuring device 189, which detects a relative displacement between the mount 5 and the pivotably mounted profiled piece 8.

By integrating the measuring devices in the actuator drives 181 and 180, distortions to the measurement results can be prevented, for example due to environmental influences, and on the other hand pulses per revolution detected by incremental transmitters can be read into the memory and control unit 175 for processing data via a signal and/or data line. This reduces structural requirements in terms of complicated cable ducts and wiring for the signal and/or data line to a minimum because no additional lines are needed to transmit data.

An adjusting and fixing procedure of the steering shaft 2 is activated and run via the preferably centralised memory and control unit 175 wired to the drive systems 176, 179 and 180 and the data relating to the actuator drives 177, 181 an d 187 needed for a desired-actual comparison to be run in the memory and control unit 175 can be forwarded via connecting lines 190. If using external measuring devices 186 and 189, etc., the data and/or signals are also forwarded to the memory and control unit 175 via the connecting lines. The memory and control unit 175 is provided in the form of a microprocessor 191 connected to the connecting line 190 and control line 192. It has at least one connecting unit for control purposes, which is either integrated or, as illustrated, linked via control lines 192 of the memory and control unit 175, and at least one operating unit 193 or 194. At least the operating unit 193 having an operating panel 195 is used to activate and operate an adjustment in the longitudinal direction—indicated by double arrow 11—and/or in a direction disposed radially thereto—indicated by double arrow 12—so that when a command is issued by the operator, the steering shaft 2 is moved in at least one axial direction. The operating panel 195 may be provided in the form of four independently operated operating elements 196, for example, and/or by two tilting levers forming the operating elements 196.

The settings stored in the memory and control unit 175 with their associated values fixed by means of the measuring devices, such as outward pivot angle, displacement path of two components of the adjusting mechanism 3 displaced relative to one another, can be retrieved in another operating unit 194, after which an automatic adjustment or a displacement—as indicated by double arrows 11 and 12—can be made by means of an operating element 197 selected by the operator by retrieving values assigned to an operating panel 198. Naturally, the operating panel 198 may also be combined with the operating panel 195 of the operating unit 193. The settings for a specific position of the steering wheel defined by the operator and stored under this panel 198 may optionally be retrieved via the control system by operating the operating elements 197 whilst adjusting the steering wheel, along with other values stored under this operating panel 198, for example for adjusting the seat position, mirror, belt height, etc.. The associated stored data may also be stored in and retrieved from the central memory and control unit 175 or a separate, decentralised memory unit 199. For practical purposes, the operating units 193 and 194 are within reach of the doors on the driver's side and/or passenger's side and the operating elements 196 and 197 may be provided in the form of keys, switches, tilting levers and similar. The operating elements 196 and 197 may naturally also be operated via the onboard computer fitted with touch screen in the vehicle interior.

An adjustment procedure is operated as described below.

If the position of the steering wheel setting is to be changed, at least one action is activated which triggers operation of the operating panel and a signal is transmitted via the control lines 192 and/or the connecting lines 190, which commands the drive system 176 assigned to the fixing system 4, which is then moved from a fixing locked position into a non-clamped open position, whereby the retaining torque of the actuator drive 177 is overcome when current is applied and the drive shaft of the actuator drive 177 is rotated in order to counteract the action of elastic resilient elements 88, lifting the clamping force or tensioning force of the fixing mechanisms 13 and/or 14 and enabling a longitudinal and/or angular adjustment of the steering shaft 2. In the subsequent step, the operator can move the steering shaft 2 using the cursor arrows of the operating elements 196 in two spatial directions. On expiry of a period of time, which may be pre-set, the fixing mechanisms 13 and/or 14 are automatically moved form a non-clamped open position into a fixed locking position. Naturally, it is also possible to exit from a set position, for example also by operating an operating key 200. Once the fixed locking position is reached, the values and data read by the measuring devices 186 and 189 or the values and data read by the measuring device of the actuator drives 181, 187 are transmitted via the connecting lines 190 to the memory and control unit 175, where they are stored. Likewise, adjustments may also be made to the seat, mirror positions or belt height and the settings that are optimum for the operator are stored in the memory unit 199 and/or in the memory and control unit 175. The individual settings specifically tailored to the user may be retrieved via the operating panel 198 schematically illustrated in FIG. 25. Operating one of several operating elements 197 initiates the automatic movement or adjustment to a position of the steering wheel, seat, etc., individually set by the operator.

The advantage of this type of embodiment primarily resides in the fact that it reduces the risk of accidents because adjustments are generally made during day to day use whilst driving, without too much attention being paid, and attention is no longer concentrated on the traffic. Using standardised, inexpensive actuator drives 177, 181 and 187 brings a reduction in the costs of manufacturing such steering shaft adjusting units 1 on the one hand and on the other hand offers a high degree of operating safety with the shortest adjustment times.

Finally, for the sake of good order, it should be pointed out that in order to provide a clearer understanding of the structure of the adjusting and fixing unit, it and its constituent parts are illustrated to a certain extent out of scale and/or shown on an enlarged scale and/or on a reduced scale.

The objective underlying the independent solutions proposed by the invention may be found in the associated parts of the description.

Above all, the individual embodiments of the subject matter illustrated in FIGS. 1, 2, 3; 4, 5, 6, 7, 8; 9, 10, l1, 12; 13, 14, 15; 16, 17, 18, 19; 20, 21, 22; 23, 24; 25 may be construed as independent solutions proposed by the invention. The associated objectives and solutions proposed by the invention may be found in the detailed descriptions.

### List of Reference Numbers

| | |
|---|---|
| 1 | Steering shaft adjusting unit |
| 2 | Steering shaft |
| 3 | Adjusting mechanism |
| 4 | Fixing system |
| 5 | Mount |
| 6 | Bodywork |
| 7 | Pivot axis |
| 8 | Profiled piece |
| 9 | Guide element |
| 10 | Bearing element |
| 11 | Double arrow |
| 12 | Double arrow |
| 13 | Fixing mechanism |
| 14 | Fixing mechanism |
| 15 | Surface |
| 16 | Surface |
| 17 | Mid-line |
| 18 | Leg |
| 19 | Height |
| 20 | Length |
| 21 | Width |
| 22 | Cutout |
| 23 | Diameter |
| 24 | Tensioning element |
| 25 | Adjustment path |
| 26 | Mid-line |
| 27 | Axis of symmetry |
| 28 | Distance |
| 29 | Height |
| 30 | Side leg |
| 31 | External face |
| 32 | Base |
| 33 | Internal face |
| 34 | Angle |
| 35 | End part |
| 36 | Intermediate part |
| 37 | Guide mechanism |
| 38 | Support and/or guide surface |
| 39 | Opening width |
| 40 | Bore |
| 41 | Diameter |
| 42 | Steering shaft mid-line |
| 43 | Cutout |
| 44 | Part |
| 45 | Part |
| 46 | Height |
| 47 | Height |
| 48 | End face |
| 49 | End face |
| 50 | Dividing plane |
| 51 | Wall thickness |
| 52 | Wall thickness |
| 53 | Cross section |
| 54 | Base |
| 55 | Width dimension |
| 56 | Width dimension |
| 57 | Side leg |
| 58 | Angle |
| 59 | Intermediate part |
| 60 | End part |
| 61 | Base |
| 62 | Side leg |
| 63 | Initial part |
| 64 | Intermediate part |
| 65 | End part |
| 66 | External face |
| 67 | Internal face |
| 68 | Hollow throat |
| 69 | End face |
| 70 | End face |
| 71 | Support and guide surface |
| 72 | Height |
| 73 | Axis of symmetry |
| 74 | Angle |
| 75 | Length |
| 76 | End face |
| 77 | End face |
| 78 | Bearing receiving point |
| 79 | Bearing receiving point |
| 80 | Bearing |
| 81 | Bearing |
| 82 | Disc cam |
| 83 | Disc cam |
| 84 | Lever |
| 85 | Plastics disc |
| 86 | Sheet metal disc |
| 87 | Base piece |
| 88 | Resilient element |
| 89 | Guide element |
| 90 | Bore |
| 91 | Surface |
| 92 | Side |
| 93 | Side |
| 94 | Longitudinal mid-line |
| 95 | Mid-line |
| 96 | Clamping element |
| 97 | Height |
| 98 | Width |
| 99 | Diameter |
| 100 | Underside |
| 101 | Cutout |
| 102 | Width |
| 103 | Width dimension |
| 104 | Width |
| 105 | Teeth |
| 106 | Distance |
| 107 | End face |
| 108 | End face |
| 109 | Guide and/or stop element |
| 110 | Height |
| 111 | Top edge |
| 112 | Width |
| 113 | Side face |
| 114 | Sideface |
| 115 | Stop surface |
| 116 | Stop surface |
| 117 | Bore |
| 118 | Tab |
| 119 | Damping element |
| 120 | Adjustment path |
| 121 | Spring |
| 122 | Bottom edge |
| 123 | Bore |
| 124 | End face |
| 125 | End face |
| 126 | Cutout |
| 127 | Side web |
| 128 | Side web |
| 129 | Intermediate web |
| 130 | Wing element |
| 131 | Stroke |
| 132 | Spring |
| 133 | Distance |
| 134 | Corner region |
| 135 | Bore |
| 136 | Depth |
| 137 | Recess |
| 138 | Recess |
| 139 | Wall part |
| 140 | Width |
| 141 | Length |
| 142 | Cutout |
| 143 | Internal diameter |
| 144 | External diameter |
| 145 | Underside |
| 146 | Projection |
| 147 | Full height |
| 148 | Guide and stop element |
| 149 | Stop surface |
| 150 | End position |
| 151 | End position |
| 152 | Curved piece |
| 153 | Radius |
| 154 | Top face |
| 155 | Opening |
| 156 | Leg |
| 157 | Angle |
| 158 | Width |
| 159 | Surface |
| 160 | — |
| 161 | Cutout |
| 162 | Depth |
| 163 | Groove |
| 164 | Shoulder |
| 165 | Body |
| 166 | Compartment |
| 167 | Compartment |
| 168 | Clamping element |
| 169 | Roll |
| 170 | Wall part |
| 171 | Compression spring |
| 172 | Support surface |
| 173 | Support surface |
| 174 | Lifting mechanism |
| 175 | Memory and control unit |
| 176 | Drive system |
| 177 | Actuator drive |
| 178 | Electric motor |
| 179 | Drive system |
| 180 | Drive system |
| 181 | Actuator drive |
| 182 | Positioning element |
| 183 | Pivot radius |
| 184 | Rack segment |
| 185 | Front edge |
| 186 | Measuring device |
| 187 | Actuator drive |
| 188 | Positioning element |
| 189 | Measuring device |
| 190 | Connecting line |
| 191 | Microprocessor |
| 192 | Control line |
| 193 | Operating unit |
| 194 | Operating unit |
| 195 | Operating panel |
| 196 | Operating element |
| 197 | Operating element |
| 198 | Operating panel |
| 199 | Memory unit |
| 200 | Operating key |

1. Adjusting mechanism for a steering shaft, which is disposed in a stationary mounting point in a vehicle so as to be slidable in the direction of the longitudinal axis of the steering shaft and pivotable in at least one direction disposed radially thereto, the telescopically extendable steering shaft being retained by means of bearings in a bearing part of a bearing element so as to be slidable in the longitudinal direction of the steering shaft with and/or relative to this bearing part and/or pivotable relative to the mount, and being fixedly retained by means of at least one fixing mechanism, and the fixing mechanism has a tensioning element extending transversely to the longitudinal axis of the steering shaft on which fixing mechanisms mutually adjustable by means of a lever are provided, at least one of which has respectively at least one base piece with at least one clamping element, at least one guide element and at least one resilient element, the clamping elements of which are designed to provide a clamp connection between the steering shaft or the bearing element and the mount, characterised in that at least one clamping element (96; 168) is disposed between the steering shaft (2) and the bearing element (10) and/or between the mount (5) and the lever (84), and in a locked position the clamping element (96; 168) or the clamping elements (96; 168) releasably fix the steering shaft (2) or the bearing element (10) and/or the mount (5) in its position relative to the tensioning element (24) against the action of elastically deformable resilient element (88) by means of an intermittent and/or linear friction connection.

2. Adjusting mechanism as claimed in claim 1, characterised in that, in a non-clamped open position, the guide elements (89) of the fixing mechanisms (13; 14) are guided without any clearance by means of the resilient elements (88) on surfaces (15; 16), facing the latter, of the mount (5) and/or the bearing element (10).

3. Adjusting mechanism as claimed in claim 1 or 2, characterised in that, in a non-clamped open position, the clamping elements (96) of the fixing mechanisms (13; 14) extend at a distance from the surfaces (15; 16) directed towards them.

4. Adjusting mechanism as claimed in one or more of the preceding claims, characterised in that, in the locked position, the clamping elements (96) are pushed with a pre-settable pressing force against the surface (15, 16) of the mount (5) and/or the bearing element (10.)

5. Adjusting mechanism as claimed in one or more of the preceding claims, characterised in that the tensioning element (24) is a tension bolt.

6. Adjusting mechanism as claimed in one or more of the preceding claims, characterised in that the base element (87) and the guide element (89) and optionally the resilient element (88) have bores (90, 123) for receiving and radially guiding the tensioning element (24).

7. Adjusting mechanism as claimed in one or more of the preceding claims, characterised in that at least one other clamping element (96) of the fixing mechanism (13; 14) is disposed so as to produce a positive-fit engagement.

8. Adjusting mechanism as claimed in one or more of the preceding claims, characterised in that at least one shaped element for providing a positive-fit engagement is provided on one of the surfaces (15; 16) of the mount (5) and/or the bearing element (10).

9. Adjusting mechanism as claimed in one or more of the preceding claims, characterised in that, mounted in the mount (5) fixedly joined to the bodywork (6), the adjusting mechanism (3) has a profiled piece (8) mounted so as to be pivotable about a pivot axis (7) with the longitudinally slidable bearing element (10) guided therein.

10. Adjusting mechanism as claimed in one or more of the preceding claims, characterised in that the mount (5) is of a profiled design and has a circular and/or multi-cornered, in paticular U-shaped, cross section in a plane perpendicular to its longitudinal extension.

11. Adjusting mechanism as claimed in one or more of the preceding claims, characterised in that a leg (18) of the U-shaped mount (5) is provided with an orifice (22) through which the tensioning element (24) extends.

12. Adjusting mechanism as claimed in one or more of the preceding claims, characterised in that an orifice (22) extending substantially transversely to the longitudinal direction of the steering shaft (2) has an arcuate, convex contour directed towards the pivot axis (7).

13. Adjusting mechanism as claimed in one or more of the preceding claims, characterised in that a length (20) of the orifice (22) bounds an adjustment path (25) of the steering shaft (2) transversely to the longitudinal extension thereof.

14. Adjusting mechanism as claimed in one or more of the preceding claims, characterised in that the profiled piece (8) has a multi-cornered, in particular U-shaped, cross section in a plane perpendicular to its longitudinal extension.

15. Adjusting mechanism as claimed in one or more of the preceding claims, characterised in that a base (32) of the profiled piece (8) adjacent to the leg (18) with the orifice (22) is provided with a bore (40) through which the tensioning element (24) extends, in which the tensioning element (24) is radially guided.

16. Adjusting mechanism as claimed in one or more of the preceding claims, characterised in that two oppositely lying, spaced apart side legs (30) extend starting from the base (32) in the direction of the other leg (18) of the mount (5) at least across a part of an opening width (39).

17. Adjusting mechanism as claimed in one or more of the preceding claims, characterised in that, in the transition region between the base (32) and the side legs (30), the profiled piece (8) forms a guide mechanism (37) extending parallel with the steering shaft (2) for the longitudinal displacement of the bearing element (10).

18. Adjusting mechanism as claimed in one or more of the preceding claims, characterised in that the guide mechanisms (37) form support and/or guide surfaces (38).

19. Adjusting mechanism as claimed in one or more of the preceding claims, characterised in that the support and/or guide surfaces (38) extend parallel with or at an angle to the base (32).

20. Adjusting mechanism as claimed in one or more of the preceding claims, characterised in that the support and/or guide surfaces (38) extend at an angle towards one another in the direction of the base (32).

21. Adjusting mechanism as claimed in one or more of the preceding claims, characterised in that the support and/or guide surfaces (38) forming the guide tracks subtend an angle of more than 90° in a cross-sectional plane.

22. Adjusting mechanism as claimed in one or more of the preceding claims, characterised in that the bearing element (10), mounted in the profiled piece (8) so as to be longitudinally slidable, is provided with a cutout (43) in a base (54) directed towards the orifice (22) extending in the longitudinal extension of the steering shaft (2) through which the clamping element (24) extends.

23. Adjusting mechanism as claimed in one or more of the preceding claims, characterised in that the cutout (43) in the bearing element (10) overlaps at least partially with the orifice (22) in the mount (5) and the orifice (22) and the cutout (43) are disposed transversely to one another.

24. Adjusting mechanism as claimed in one or more of the preceding claims, characterised in that the bearing element (10) has a first part (44) provided with the cutout (43) and another part (45) joined, in particular welded, thereto.

25. Adjusting mechanism as claimed in one or more of the preceding claims, characterised in that the first part (44) and the other part (45) have a multi-cornered cross section in a plane perpendicular to their longitudinal extension.

26. Adjusting mechanism as claimed in one or more of the preceding claims, characterised in that the first part (44) has a substantially trapezoid cross section.

27. Adjusting mechanism as claimed in one or more of the preceding claims, characterised in that the other part (44) has a substantially U-shaped cross section.

28. Adjusting mechanism as claimed in one or more of the preceding claims, characterised in that the first part (44) has two side legs (57) inclined in mirror image towards a base (54) and in a direction remote from the orifice (22).

29. Adjusting mechanism as claimed in one or more of the preceding claims, characterised in that guide elements (9) co-operate with the side legs (57).

30. Adjusting mechanism as claimed in one or more of the preceding claims, characterised in that the guide elements (9) are provided in the form of guide strips, guide depressions, guide arms, etc..

31. Adjusting mechanism as claimed in one or more of the preceding claims, characterised in that the guide elements (9) have a substantially trapezoid cross section matching the guide mechanism (37) in a plane perpendicular to their longitudinal extension.

32. Adjusting mechanism as claimed in one or more of the preceding claims, characterised in that the guide elements (9) provided for adjusting the length of the telescopically adjustable steering shaft (2) are of a length that is the same as an adjustment path (120), in particular a length projecting beyond the length of the profiled piece (8).

33. Adjusting mechanism as claimed in one or more of the preceding claims, characterised in that a cam disc (82; 83) is provided between the lever (84) rotatably or pivotably mounted on the tensioning element (24) and the clamping element or elements (96), generating a clamping force at least in the longitudinal extension of the tensioning element (24) when the lever (84) is pivoted into the locked position

34. Adjusting mechanism as claimed in one or more of the preceding claims, characterised in that the cam disc (82) is integrally formed on the fixing mechanism (13) or is joined, in particular welded, thereto.

35. Adjusting mechanism as claimed in one or more of the preceding claims, characterised in that at least one of the mutually facing end faces of the relatively rotatable cam discs (82, 83) has a rising screw surface in the direction of the longitudinal axis of the tensioning element (24).

36. Adjusting mechanism as claimed in one or more of the preceding claims, characterised in that the base element (87) has a longer length in the direction of the steering shaft (2) than in a direction extending transversely thereto.

37. Adjusting mechanism as claimed in one or more of the preceding claims, characterised in that the elastic resilient element (88) co-operating with the base element (87) is disposed between the base element (87) and the guide element (89) overlapping with the surface (15; 16).

38. Adjusting mechanism as claimed in one or more of the preceding claims, characterised in that the base element (87) forms a cutout (101) in an underside (100) remote from the base (54) in which the tensioning element (24) is received so as to be prevented from rotating.

39. Adjusting mechanism as claimed in one or more of the preceding claims, characterised in that the clamping element or elements (96) are disposed perpendicular to or at an angle to the surface (91) of the base element (87) extending parallel with a bottom edge (122).

40. Adjusting mechanism as claimed in one or more of the preceding claims, characterised in that clamping elements (96) are disposed in the longitudinal extension and/or transversely to the longitudinal extension and/or at least at an angle to the longitudinal extension of the base element (87).

41. Adjusting mechanism as claimed in any one of the preceding claims, characterised in that the clamping elements (96) extending across at least a part of the length of the base element (87) are disposed on the two oppositely lying sides (92, 93) of the base element (87).

42. Adjusting mechanism as claimed in any one of the preceding claims, characterised in that several clamping elements (96) are disposed on the two oppositely lying sides (92, 93) spaced apart in the longitudinal extension of the base element (87).

43. Adjusting mechanism as claimed in one or more of the preceding claims, characterised in that a width (102) between longitudinal side faces of the base element (87) is slightly smaller than a width dimension (103) as measured on a bottom edge (122) transversely to the longitudinal extension of the bearing element (10).

44. Adjusting mechanism as claimed in one or more of the preceding claims, characterised in that the clamping element (96) is provided with teeth (105) extending at least at an angle to the direction of the longitudinal displacement of the bearing element (10) and the steering shaft (2).

45. Adjusting mechanism as claimed in one or more of the preceding claims, characterised in that the clamping element (96) has a structured surface or profiling or similar.

46. Adjusting mechanism as claimed in one or more of the preceding claims, characterised in that the base element (87) forms at least one guide and/or stop surface (109) projecting into the cutout (43) of the bearing element (10).

47. Adjusting mechanism as claimed in one or more of the preceding claims, characterised in that the guide and/or stop element (109) is formed by a substantially U-shaped projection projecting beyond the surface (91).

48. Adjusting mechanism as claimed in one or more of the preceding claims, characterised in that the guide and/or stop element (109) disposed between the oppositely lying clamping elements (96) is arranged in the longitudinal extension of the base element (87), preferably on the two oppositely lying end faces (107, 108).

49. Adjusting mechanism as claimed in one or more of the preceding claims, characterised in that a width (112) of the guide and/or stop element (109) is bounded by side faces (113, 114) running in the longitudinal extension of the base element (87) and the latter form lateral guide tracks.

50. Adjusting mechanism as claimed in one or more of the preceding claims, characterised in that a height (97) of the clamping elements (96) measured perpendicular to the surface (91) of the base element (87) is shorter than a height (110) of the guide and/or stop element (109).

51. Adjusting mechanism as claimed in one or more of the preceding claims, characterised in that the resilient element (88) is a plate spring or a compression spring.

52. Adjusting mechanism as claimed in one or more of the preceding claims, characterised in that the resilient element (88) is made from a material other than iron, in particular from an elastic synthetic material.

53. Adjusting mechanism as claimed in one or more of the preceding claims, characterised in that the guide element (89) is substantially strip-shaped.

54. Adjusting mechanism as claimed in one or more of the preceding claims, characterised in that the cross-sectional shape formed by the surface (91) of the base element (87) substantially matches the shape of the guide element (89).

55. Adjusting mechanism as claimed in one or more of the preceding claims, characterised in that stop surfaces extend on the two oppositely lying end regions of the cutout (43) across the width (104) of the cutout (43).

56. Adjusting mechanism as claimed in one or more of the preceding claims, characterised in that tabs (118) are provided on the two oppositely lying end regions of the cutout (43) substantially perpendicular to the longitudinal extension of the bearing element (10).

57. Adjusting mechanism as claimed in one or more of the preceding claims, characterised in that the tabs (118) are integrally formed on the bearing element (10) and/or are joined, in particular welded, thereto.

58. Adjusting mechanism as claimed in one or more of the preceding claims, characterised in that a bore (117) formed by the tab (118) holds a damping element (119) in position, for example an elastomer damper, spring damper, etc..

59. Adjusting mechanism as claimed in one or more of the preceding claims, characterised in that the oppositely lying damping elements (119) bounding the adjustment path (120) co-operate alternately with the guide and/or stop elements (109).

60. Adjusting mechanism as claimed in one or more of the preceding claims, characterised in that clamping elements (168) are disposed in compartments (166, 167) of the fixing mechanisms (13; 14), preferably in the form of at least one roller (169) or clamping wedge, etc...

61. Adjusting mechanism as claimed in one or more of the preceding claims, characterised in that compartments (166, 167) of the fixing mechanism (13, 14) arranged in mirror image have support surfaces (172, 173) tapering in a conical arrangement in the direction the clamping element (24).

62. Adjusting mechanism as claimed in one or more of the preceding claims, characterised in that a lifting mechanism (174) is joined so as to be integral with the tensioning element (24) in rotation or is integrally formed thereon and forms a spiral curved contour, in particular an eccentric or cam, etc..

63. Adjusting mechanism as claimed in one or more of the preceding claims, characterised in that the clamping elements (168) disposed in the compartments (166, 167) of the fixing mechanisms (13; 14) are biassed starting from the tensioning element (24) in the direction of the support surfaces (172, 173) of the fixing mechanism (13, 14) by means of a spring arrangement, e.g. compression springs (171), etc..

64. Adjusting mechanism as claimed in one or more of the preceding claims, characterised in that the bearing part forming a bearing receiving point (78, 79) on the bearing element (10) is integrally formed thereon and/or is joined thereto.

65. Adjusting mechanism as claimed in one or more of the preceding claims, characterised in that a plastics disc (85) disposed on the tensioning element (24) with a bigger diameter than a width (104) of the cutout (43) passes across and overlaps a surface of the base (54) of the first part (44) directed towards the profiled piece (8), which is positioned and fixedly retained in the axial direction by another sheet metal disc (86) joined, in particular welded, adhered, soldered, etc., to the tensioning element (24).

66. Adjusting mechanism as claimed in one or more of the preceding claims, characterised in that at least one drive system (176; 179; 180) is assigned to the fixing mechanisms (13; 14) and the adjusting mechanism (3) respectively.

67. Adjusting mechanism as claimed in one or more of the preceding claims, characterised in that the drive system (176) of the fixing mechanisms (13; 14) has an actuator drive (177), in particular a threaded spindle, optionally with different thread pitches.

68. Adjusting mechanism as claimed in one or more of the preceding claims, characterised in that an electric motor (178) is disposed on a side face of the base element (87) of the fixing mechanism (13) extending parallel with the surface (15) remote from the leg (18).

69. Adjusting mechanism as claimed in one or more of the preceding claims, characterised in that a rack gear system is provided for the drive system (179) to adjust the angular position transversely to the longitudinal direction of the steering shaft (2) and for the drive system (180) to adjust the longitudinal position of the steering shaft (2).

70. Adjusting mechanism as claimed in one or more of the preceding claims, characterised in that an electric motor (178) for adjusting the angular position is provided with an end gear co-operating with the end-side front region of the mount (5) and a rack segment (184) curving in a convex arrangement towards the pivot axis (7)of the base (54) of the profiled piece (8) drivingly linked thereto.

71. Adjusting mechanism as claimed in one or more of the preceding claims, characterised in that the electric motor (178) for making the length adjustment is provided with an end gear co-operating with the end-side front region of the profiled piece (8) and the straight rack segment (184) drivingly linked therewith, which is disposed on the side leg (57; 62) of the bearing element (10).

72. Adjusting mechanism as claimed in one or more of the preceding claims, characterised in that the drive system (176; 179; 180) has an electric motor (178), in particular a stepper motor or servo motor and such like, with a gear and brake mechanism and optionally a measuring sensor.

73. Adjusting mechanism as claimed in one or more of the preceding claims, characterised in that the drive systems (176, 179, 180) are wired to at least one central or decentralised memory and control unit (175).

74. Adjusting mechanism as claimed in one or more of the preceding claims, characterised in that the drive systems (176, 179, 180) can be remotely operated directly with an operating unit (193; 194) and the inclination and/or the length of the steering shaft (2) optionally adjusted.

75. Fixing mechanism for a steering shaft adjusting unit having at least one base element with at least one clamping element, at least one elastically deformable resilient element co-operating therewith and at least one guide element supported on the resilient element, arranged on a tensioning element disposed transversely to a steering shaft, characterised in that the resilient element (88) is designed to act as a damping element in the direction extending transversely to the longitudinal direction of the tensioning element (24).

76. Fixing mechanism as claimed in claim 75, characterised in that the resilient element (88) is designed to act as a damping element in the longitudinal direction of the tensioning element (24).

77. Fixing mechanism as claimed in claim 75 or 76, characterised in that the guide element (89) has at least one guide and stop element (149) with a cutout (142) extending in the longitudinal extension of the guide element (89) through which the tensioning element (24) extends and the guide element (89) can be adjusted relative to the base element (87) in the direction of the longitudinal displacement of the steering shaft (2) and/or in a clamping direction extending transversely thereto.

78. Fixing mechanism as claimed in claim 75 or 77, characterised in that the base element (87) has at least one cutout (161) of a rectangular shape, for example, recessed into the surface (91) between the clamping elements (96) extending in the direction of a length of the base element (87).

79. Fixing mechanism as claimed in one of claims 75 to 78, characterised in that the base element (87) is provided with a groove (163), between the clamping elements (96) projecting on either side beyond a width of the cutout (161) transversely to the longitudinal extension of the base element (87) for receiving the resilient element (88).

80. Fixing mechanism as claimed in one of claims 75 to 79, characterised in that the depth (162) as measured perpendicular to the surface (91) of the base element (87) is smaller than a depth of the groove (163) for receiving the resilient element (88).

81. Fixing mechanism as claimed in one of claims 75 to 80, characterised in that a shoulder (164) extending radially around and adjoining the bore (90) of the base element (87) stands proud of the surface (91).

82. Fixing mechanism as claimed in one of claims 75 to 81, characterised in that the resilient element (88) is retained in position by the shoulder (164).

83. Fixing mechanism as claimed in one of claims 75 to 82, characterised in that the guide element (89) has projections (146) on an underside (145) adjacent to the base element (87) with a concave curved piece directed towards the tensioning element (24) and the base element (87) lying opposite the latter, in particular the shoulder (164), in a side directed towards the guide element (89), has a convex curved piece directed towards the tensioning element (24), between which the resilient element (88) is held and/or fixed in position.

84. Fixing mechanism as claimed in one of claims 75 to 83, characterised in that the resilient element (88) is made from an elastic part made from synthetic material.

85. Fixing mechanism as claimed in one of claims 75 to 84, characterised in that the resilient element (88) is an elastic O-ring.
